(19) United States
(12) Patent Application Publication
(10) Pub. No.: US 2025/0391372 A1
(43) Pub. Date: Dec. 25, 2025

(54) DRIVING CIRCUIT, DRIVING METHOD AND DISPLAY DEVICE

(71) Applicants: CHENGDU BOE OPTOELECTRONICS TECHNOLOGY CO., LTD., Chengdu, Sichuan (CN); BOE TECHNOLOGY GROUP CO., LTD., Beijing (CN)

(72) Inventors: Ziyang YU, Beijing (CN); Haijun QIU, Beijing (CN); Ming HU, Beijing (CN); Zhiliang JIANG, Beijing (CN); Tianyi CHENG, Beijing (CN); Jianpeng WU, Beijing (CN); Mengqi WANG, Beijing (CN); Qi WEI, Beijing (CN); Wenbo CHEN, Beijing (CN); Qingqing YAN, Beijing (CN); Mingfang WANG, Beijing (CN); Pan ZHAO, Beijing (CN)

(21) Appl. No.: 18/996,780

(22) PCT Filed: May 16, 2024
(86) PCT No.: PCT/CN2024/093524

§ 371 Date: Jan. 17, 2025

(30) Foreign Application Priority Data
Jun. 16, 2023 (CN) 202310720909.3

(51) Int. Cl. G09G 3/3258

(52) U.S. Cl. CPC G09G 3/3258; G09G 2300/0819; G09G 2300/0842; G09G 2300/0861; G09G 2310/08; G09G 2330/021

(57) ABSTRACT

A driving circuit, a driving method and a display device are provided. The driving circuit includes a driving signal generating circuit, M output driving terminals and M control circuits; the m-th control circuit includes an m-th gating circuit, an m-th output control circuit and an m-th output circuit; the driving signal generating circuit outputs an N-th level driving signal; the m-th gating circuit controls the writing of the m-th gating input signal into the m-th first node under the control of the m-th gating control signal; the m-th output control circuit performs a non-AND operation on the potential of the N-th level driving signal and the second terminal of the m-th output control circuit to obtain the m-th first output signal; the m-th output circuit inverts the m-th first output signal to obtain the m-th output driving signal.

### CROSS REFERENCE OF RELATED APPLICATION

The present disclosure is the U.S. national phase of PCT Application PCT/CN2024/093524 filed on May 16, 2024, which claims a priority of Chinese patent disclosure No. 202310720909.3 filed on Jun. 16, 2023, which is incorporated herein by reference in its entirety.

### TECHNICAL FIELD

The present disclosure relates to the field of display technology, and in particular to a driving circuit, a driving method and a display device.

### BACKGROUND

In the related art, when an OLED (organic light-emitting diode) display updates the screen, it is necessary to initialize and write the pixel voltage of all rows of pixel circuits within one frame time. However, in some special screens (such as the AOD display screen (the AOD display screen is a screen that controls the partial lighting of the screen without lighting the entire mobile phone screen), static screens or screens that are updated less frequently), most of the pixel circuits on the entire screen do not need to update the pixel voltage, that is, most of the pixel circuits can be maintained at the original display brightness through low-leakage LTPO (low-temperature polycrystalline oxide) TFT (thin-film transistor), and the repeated refresh of these pixel circuits causes a waste of power consumption.

### SUMMARY

In one aspect, the present disclosure provides a driving circuit, comprising a driving signal generating circuit, M output driving terminals and M control circuits; the m-th control circuit comprises an m-th gating circuit, an m-th output control circuit and an m-th output circuit; M is a positive integer; m is a positive integer less than or equal to M;

The driving signal generating circuit is electrically connected to the control clock signal terminal, the (N−1)-th level driving signal output terminal and the N-th level driving signal output terminal respectively, and is configured to perform a shift operation on the (N−1)-th level driving signal provided by the (N−1)-th level driving signal output terminal under the control of the control clock signal provided by the control clock signal terminal, so as to obtain and output the N-th level driving signal through the N-th level driving signal output terminal;
the m-th gating circuit is electrically connected to the m-th first node, the m-th gating input terminal and the m-th gating control terminal respectively, and is used for controlling the writing of the m-th gating input signal provided by the m-th gating input terminal into the m-th first node under the control of the m-th gating control signal provided by the m-th gating control terminal;
the first terminal of the m-th output control circuit is electrically connected to the N-th level driving signal output end, and the second end of the m-th output control circuit is electrically connected to the m-th first node, and is configured to perform a NAND operation on the N-th level driving signal and the potential of the second end of the m-th output control circuit to obtain the m-th first output signal;
the m-th output circuit is configured to invert the m-th first output signal, and obtain an m-th output driving signal through the m-th output driving terminal;
N is a positive integer.

Optionally, the driving circuit described in at least one embodiment of the present disclosure further includes a first inverting circuit;
the first inversion circuit is electrically connected to the control clock signal terminal and the inverted clock signal terminal respectively, and is configured to invert the control clock signal to obtain an inverted clock signal, and output the inverted clock signal through the inverted clock signal terminal;
the driving signal generating circuit is also electrically connected to the inverted clock signal terminal, and is also configured to shift the (N−1)-th level driving signal provided by the (N−1)-th level driving signal output terminal under the control of the inverted clock signal, to obtain and output the N-th level driving signal through the N-th level driving signal output terminal.

Optionally, the m-th gating circuit is configured to control the writing of the m-th selection input signal provided by the m-th selection input terminal into the m-th first node when the potential of the (N−1)-th level driving signal is the first voltage and the potential of the N-th level driving signal is the second voltage.

Optionally, the m-th gating control terminal includes an m-th first control terminal, an m-th second control terminal, an m-th third control terminal and an m-th fourth control terminal, and the m-th gating circuit includes an m-th first gating transistor, an m-th second gating transistor, an m-th third gating transistor and an m-th fourth gating transistor;
the gate of the m-th first gating transistor is electrically connected to the m-th first control terminal, and the first electrode of the m-th first gating transistor is electrically connected to the m-th gating input terminal;
the gate of the m-th second gating transistor is electrically connected to the m-th second control terminal, and the first electrode of the m-th second gating transistor is electrically connected to the m-th selection input terminal;
the gate of the m-th third gating transistor is electrically connected to the m-th third control terminal, the first electrode of the m-th third gating transistor is electrically connected to the second electrode of the m-th first gating transistor, and the second electrode of the m-th third gating transistor is electrically connected to the m-th first node;
the gate of the m-th fourth gating transistor is electrically connected to the m-th fourth control terminal, the first electrode of the m-th fourth gating transistor is electrically connected to the second electrode of the m-th second gating transistor, and the second electrode of the m-th fourth gating transistor is electrically connected to the m-th first node;
the m-th first gating transistor is a p-type transistor, the m-th second gating transistor is an n-type transistor, the m-th third gating transistor is a p-type transistor, and the m-th fourth gating transistor is an n-type transistor;
the m-th first control terminal is connected to the inverted signal of the (N−1)-th level driving signal, the m-th second control terminal is the (N−1)-th level driving signal output terminal, the m-th third control terminal is the N-th level driving signal output terminal, and the m-th fourth control terminal is connected to the inverted signal of the N-th level driving signal; or, the m-th first control terminal is connected to the inverted signal of the N-th level driving signal, the m-th second control terminal is the N-th level driving signal output terminal, the m-th third control terminal is the (N−1)-th level driving signal output terminal, and the m-th fourth control terminal is connected to the inverted signal of the (N−1)-th level driving signal.

Optionally, the second electrode of the m-th first gating transistor is electrically connected to the second electrode of the m-th second gating transistor.

Optionally, the m-th gating circuit includes an m-th first gating transistor;
the gate of the m-th first gating transistor is electrically connected to the m-th selection control terminal, the first electrode of the m-th first gating transistor is electrically connected to the m-th first node, and the second electrode of the m-th first gating transistor is electrically connected to the m-th selection input terminal.

Optionally, the m-th gating control terminal includes an m-th first control terminal and an m-th second control terminal; the m-th gating circuit includes an m-th first gating transistor and an m-th second gating transistor;
the gate of the m-th first gating transistor is electrically connected to the m-th first control terminal, the first electrode of the m-th first gating transistor is electrically connected to the m-th first node, and the second electrode of the m-th first gating transistor is electrically connected to the first electrode of the m-th second gating transistor;
the gate of the m-th second gating transistor is electrically connected to the m-th second control terminal, and the second electrode of the m-th second gating transistor is electrically connected to the m-th selection input terminal;
the m-th first control terminal is the (N−1)-th level driving signal output terminal, the m-th second control terminal is the N-th level driving signal output terminal, the m-th first gating transistor is an n-type transistor, and the m-th second gating transistor is a p-type transistor; or,
the m-th first control terminal is the N-th level driving signal output terminal, the m-th second control terminal is the (N−1)-th level driving signal output terminal, the m-th first gating transistor is a p-type transistor, and the m-th second gating transistor is an n-type transistor; or,
the m-th first control terminal is connected to the inverted signal of the (N−1)-th level driving signal, the m-th second control terminal is the N-th level driving signal output terminal, and the m-th first gating transistor and the m-th second gating transistor are both p-type transistors; or,
the m-th first control terminal is an output terminal of the N-th level driving signal, and the m-th second control terminal is connected to the inverted signal of the (N−1)-th level driving signal; the m-th first gating transistor and the m-th second gating transistor are both p-type transistors; or,
the m-th first control terminal is the (N−1)-th level driving signal terminal, the m-th second control terminal is connected to the inverted signal of the N-th level driving signal, and the m-th first gating transistor and the m-th second gating transistor are both n-type transistors; or,
the m-th first control terminal is connected to the inverted signal of the N-th level driving signal, the m-th second control terminal is the (N−1)-th level driving signal terminal, and the m-th first gating transistor and the m-th second gating transistor are both n-type transistors.

Optionally, the m-th control circuit further includes an m-th first initialization circuit;
the m-th first initialization circuit is electrically connected to the initial control terminal, the first voltage terminal and the m-th first node respectively, and is configured to control the connection between the m-th first node and the first voltage terminal under the control of the initial control signal provided by the initial control terminal.

Optionally, the m-th control circuit further includes an m-th reset circuit;
the m-th reset circuit is electrically connected to the first voltage terminal, the (N−1)-th level driving signal output terminal, the (N−1)-th level driving signal output terminal and the m-th first node, respectively, and is configured to control the connection between the m-th first node and the first voltage terminal under the control of the (N−1)-th level driving signal and the (N−1)-th level driving signal provided by the (N−1)-th level driving signal output terminal.

Optionally, the m-th control circuit further includes an m-th first voltage maintaining circuit;
the first terminal of the m-th first voltage maintaining circuit is electrically connected to the m-th first node, the second end of the m-th first voltage maintaining circuit is electrically connected to the DC voltage end, and the m-th voltage maintaining circuit is configured to maintain the potential of the m-th first node.

Optionally, the m-th control circuit further includes an m-th second voltage maintaining circuit; the m-th first node is electrically connected to the second end of the m-th output control circuit through the m-th second voltage maintaining circuit;
the m-th second voltage maintaining circuit comprises an m-th first inverter, an m-th second inverter and an m-th maintaining control circuit;
the input end of the m-th first inverter is electrically connected to the m-th first node, the output end of the m-th first inverter is electrically connected to the m-th second node, the input end of the m-th second inverter is electrically connected to the m-th second node, and the output end of the m-th second inverter is electrically connected to the m-th third node and the second end of the m-th output control circuit;
the m-th first inverter is configured to invert the potential of the m-th first node, and output the inverted potential of the m-th first node through the output end of the m-th first inverter, and the m-th second inverter is configured to invert the potential of its input end, and output the inverted potential through the output end of the m-th second inverter;
the m-th maintaining control circuit is electrically connected to the m-th maintaining control terminal, the m-th third node and the m-th first node respectively, and is configured to control the connection or disconnection between the m-th third node and the m-th first node under the control of the m-th maintaining control signal provided by the m-th maintaining control terminal.

Optionally, the m-th reset circuit includes an m-th first transistor and an m-th second transistor;
the gate of the m-th first transistor is electrically connected to the (N−1)-th stage driving signal output terminal, the first electrode of the m-th first transistor is electrically connected to the first voltage terminal, and the second electrode of the m-th first transistor is electrically connected to the first electrode of the m-th second transistor;
the gate of the m-th second transistor is electrically connected to the N-th stage driving signal output terminal, and the second electrode of the m-th second transistor is electrically connected to the m-th first node.

Optionally, the m-th maintaining control terminal includes an m-th first maintaining control terminal and an m-th second maintaining control terminal;
the m-th maintaining control circuit comprises an m-th third transistor and an m-th fourth transistor;
the gate of the m-th third transistor is electrically connected to the m-th first maintaining control terminal, the first electrode of the m-th third transistor is electrically connected to the m-th first node, and the second electrode of the m-th third transistor is electrically connected to the m-th third node;
the gate of the m-th fourth transistor is electrically connected to the m-th second maintaining control terminal, the first electrode of the m-th fourth transistor is electrically connected to the m-th third node, and the second electrode of the m-th fourth transistor is electrically connected to the m-th first node;
the m-th third transistor is a p-type transistor, and the m-th fourth transistor is an n-type transistor;
the m-th first maintaining control terminal is the (N−1)-th level driving signal terminal, and the m-th second maintaining control terminal is the control clock signal terminal; or,
the m-th first maintaining control terminal is an inverted clock signal terminal, and the m-th second maintaining control terminal is a control clock signal terminal.

Optionally, the m-th first inverter includes an m-th fifth transistor and an m-th sixth transistor, and the m-th second inverter includes an m-th seventh transistor and an m-th eighth transistor;
the gate of the m-th fifth transistor is electrically connected to the m-th first node, the first electrode of the m-th fifth transistor is electrically connected to the first voltage terminal, and the second electrode of the m-th fifth transistor is electrically connected to the m-th second node;
the gate of the m-th sixth transistor is electrically connected to the m-th first node, the first electrode of the m-th sixth transistor is electrically connected to the m-th second node, and the second electrode of the m-th sixth transistor is electrically connected to the second voltage terminal;
the m-th fifth transistor is a p-type transistor, and the m-th sixth transistor is an n-type transistor;

A gate of the m-th seventh transistor is electrically connected to the m-th second node, a first electrode of the m-th seventh transistor is electrically connected to the first voltage terminal, and a second electrode of the m-th seventh transistor is electrically connected to the m-th third node;
the gate of the m-th eighth transistor is electrically connected to the m-th second node, the first electrode of the m-th eighth transistor is electrically connected to the m-th third node, and the second electrode of the m-th eighth transistor is electrically connected to the second voltage terminal;
the m-th seventh transistor is a p-type transistor, and the m-th eighth transistor is an n-type transistor.

Optionally, the m-th first initialization circuit includes an m-th ninth transistor;
the gate of the m-th ninth transistor is electrically connected to the initial control terminal, the first electrode of the m-th ninth transistor is electrically connected to the first voltage terminal, and the second electrode of the m-th ninth transistor is electrically connected to the m-th first node.

Optionally, the m-th first voltage maintaining circuit includes an m-th capacitor;
the first terminal of the m-th capacitor is electrically connected to the m-th first node, and the second end of the m-th capacitor is electrically connected to a DC voltage terminal.

Optionally, the m-th output control circuit includes an m-th tenth transistor, an m-th eleventh transistor, an m-th twelfth transistor and an m-th thirteenth transistor;
the gate of the m-th tenth transistor is electrically connected to the m-th first node, the first electrode of the m-th tenth transistor is electrically connected to the first voltage terminal, and the second electrode of the m-th tenth transistor is electrically connected to the m-th second node;
the gate of the m-th eleventh transistor is electrically connected to the N-th stage driving signal output terminal, the first electrode of the m-th eleventh transistor is electrically connected to the first voltage terminal, and the second electrode of the m-th eleventh transistor is electrically connected to the m-th second node;
a gate of the m-th twelfth transistor is electrically connected to the m-th first node, a first electrode of the m-th twelfth transistor is electrically connected to the m-th second node, and a second electrode of the m-th twelfth transistor is electrically connected to a first electrode of the m-th thirteenth transistor;
the gate of the m-th thirteenth transistor is electrically connected to the N-level driving signal output terminal, and the second electrode of the m-th thirteenth transistor is electrically connected to the second voltage terminal;
the m-th tenth transistor and the m-th eleventh transistor are p-type transistors, and the m-th twelfth transistor and the m-th thirteenth transistor are n-type transistors.

Optionally, the m-th output circuit includes an m-th fourteenth transistor and an m-th fifteenth transistor;
the gate of the m-th fourteenth transistor is electrically connected to the m-th second node, the first electrode of the m-th fourteenth transistor is electrically connected to the first voltage terminal, and the second electrode of the m-th fourteenth transistor is electrically connected to the m-th output driving terminal;
the gate of the m-th fifteenth transistor is electrically connected to the m-th second node, the first electrode of the m-th fifteenth transistor is electrically connected to the m-th output driving terminal, and the second electrode of the m-th fifteenth transistor is electrically connected to the second voltage terminal.

Optionally, the driving signal generating circuit includes a first driving control circuit, a second driving control circuit, a second inverting circuit and a second initialization circuit;
the first driving control circuit is electrically connected to the control clock signal terminal, the inverted clock signal terminal, the (N−1)-th level driving signal output terminal and the fourth node respectively, and is configured to shift and invert the (N−1)-th driving signal provided by the (N−1)-th level driving signal output terminal under the control of the control clock signal provided by the control clock signal terminal and the inverted clock signal provided by the inverted clock signal terminal, and obtain and output the inverted signal through the fourth node;
the second driving control circuit is electrically connected to the control clock signal terminal, the inverted clock signal terminal, the N-th level driving signal output terminal and the fourth node respectively, and is configured to invert the N-th level driving signal provided by the N-th level driving signal output terminal under the control of the control clock signal and the inverted clock signal, and obtain and output the inverted signal through the fourth node;
the second inverting circuit is electrically connected to the fourth node and the N-th level driving signal output terminal respectively, and is configured to invert the potential of the fourth node and output the inverted signal through the N-th level driving signal output terminal;
the second initialization circuit is electrically connected to the initial control terminal, the first voltage terminal and the N-th level driving signal output terminal respectively, and is configured to control the connection between the N-th level driving signal output terminal and the first voltage terminal under the control of the initial control signal provided by the initial control terminal.

Optionally, the first driving control circuit includes a sixteenth transistor, a seventeenth transistor, an eighteenth transistor and a nineteenth transistor;
the gate of the sixteenth transistor is electrically connected to the inverted clock signal terminal, the first electrode of the sixteenth transistor is electrically connected to the first voltage terminal, and the second electrode of the sixteenth transistor is electrically connected to the first electrode of the seventeenth transistor;
the gate of the seventeenth transistor is electrically connected to the (N−1)-th stage driving signal output terminal, and the second electrode of the seventeenth transistor is electrically connected to the fourth node;
the gate of the eighteenth transistor is electrically connected to the (N−1)-th stage driving signal output terminal, the first electrode of the eighteenth transistor is electrically connected to the fourth node, and the second electrode of the eighteenth transistor is electrically connected to the first electrode of the nineteenth transistor;
the gate of the nineteenth transistor is electrically connected to the control clock signal terminal, and the second electrode of the nineteenth transistor is electrically connected to the third voltage terminal;
the sixteenth transistor and the seventeenth transistor are p-type transistors, and the eighteenth transistor and the nineteenth transistor are n-type transistors.

Optionally, the second driving control circuit includes a twentieth transistor, a twenty-first transistor, a twenty-second transistor and a twenty-third transistor;
the gate of the twentieth transistor is electrically connected to the N-th stage driving signal output terminal, the first electrode of the twentieth transistor is electrically connected to the first voltage terminal, and the second electrode of the twentieth transistor is electrically connected to the first electrode of the 21st transistor;
a gate of the twenty-first transistor is electrically connected to the control clock signal terminal, and a second electrode of the twenty-first transistor is electrically connected to the fourth node;
a gate of the 22nd transistor is electrically connected to the inverted clock signal terminal, a first electrode of the 22nd transistor is electrically connected to the fourth node, and a second electrode of the 22nd transistor is electrically connected to a first electrode of the 23rd transistor;
a gate of the twenty-third transistor is electrically connected to the N-th stage driving signal output terminal, and a second electrode of the twenty-third transistor is electrically connected to the third voltage terminal;
the twentieth transistor and the 21st transistor are p-type transistors, and the 22nd transistor and the 23rd transistor are n-type transistors.

Optionally, the second inverting circuit includes a twenty-fourth transistor and a twenty-fifth transistor; the second initialization circuit includes a twenty-sixth transistor;
the gate of the twenty-fourth transistor is electrically connected to the fourth node, the first electrode of the twenty-fourth transistor is electrically connected to the first voltage terminal, and the second electrode of the twenty-fourth transistor is electrically connected to the first electrode of the 25th transistor and the N-th stage driving signal output terminal;
a gate of the twenty-fifth transistor is electrically connected to the fourth node, and a second electrode of the twenty-fifth transistor is electrically connected to the third voltage terminal;
the twenty-fourth transistor is a p-type transistor, and the twenty-fifth transistor is an n-type transistor;
a gate of the twenty-sixth transistor is electrically connected to the initial control terminal, a first electrode of the twenty-sixth transistor is electrically connected to the first voltage terminal, and a second electrode of the twenty-sixth transistor is electrically connected to the N-th stage driving signal output terminal.

Optionally, the first inverting circuit includes a twenty-seventh transistor and a twenty-eighth transistor;
the gate of the twenty-seventh transistor is electrically connected to the control clock signal terminal, the first electrode of the twenty-seventh transistor is electrically connected to the first voltage terminal, and the second electrode of the twenty-seventh transistor is electrically connected to the first electrode of the twenty-eighth transistor and the inverted clock signal terminal;
a gate of the twenty-eighth transistor is electrically connected to the control clock signal terminal, and a second electrode of the twenty-eighth transistor is electrically connected to the third voltage terminal.

In a second aspect, an embodiment of the present disclosure provides a driving method, which is applied to the above-mentioned driving circuit, and the driving method includes:
the driving signal generating circuit performs a shift operation on the (N−1)-th level driving signal under the control of the control clock signal, obtains and outputs the N-th level driving signal through the N-th level driving signal output terminal;
the m-th gating circuit controls, under the control of the m-th gating control signal, to write the m-th gating input signal into the m-th first node;
the m-th output control circuit performs a NAND operation on the N-th stage driving signal and the potential of the second end of the m-th output control circuit to obtain an m-th first output signal;
the m-th output circuit is used for inverting the m-th first output signal, and obtaining and providing the m-th output driving signal through the m-th output driving terminal;
M is a positive integer; m is a positive integer less than or equal to M, and N is a positive integer.

In a third aspect, an embodiment of the present disclosure provides a display device, comprising the above-mentioned driving circuit.

### BRIEF DESCRIPTION OF THE DRAWINGS

FIG. 1 is a structural diagram of a driving circuit according to at least one embodiment of the present disclosure;

FIG. 2 is a structural diagram of a driving circuit according to at least one embodiment of the present disclosure;

FIG. 3 is a structural diagram of a driving circuit according to at least one embodiment of the present disclosure;

FIG. 4 is a structural diagram of a driving circuit according to at least one embodiment of the present disclosure;

FIG. 5 is a circuit diagram of a related pixel circuit;

FIG. 6 is a working timing diagram of the related pixel circuit shown in FIG. 5;

FIG. 7 is a circuit diagram of a related pixel circuit;

FIG. 8 is a circuit diagram of at least one embodiment of a gating circuit in a driving circuit according to an embodiment of the present disclosure;

FIG. 9 is a circuit diagram of at least one embodiment of a gating circuit in a driving circuit according to an embodiment of the present disclosure;

FIG. 10 is a circuit diagram of at least one embodiment of a gating circuit in a driving circuit according to an embodiment of the present disclosure;

FIG. 11 is a circuit diagram of at least one embodiment of a gating circuit in a driving circuit according to an embodiment of the present disclosure;

FIG. 12 is a circuit diagram of at least one embodiment of a gating circuit in a driving circuit according to an embodiment of the present disclosure;

FIG. 13 is a circuit diagram of at least one embodiment of a gating circuit in a driving circuit according to an embodiment of the present disclosure;

FIG. 14 is a circuit diagram of at least one embodiment of a gating circuit in a driving circuit according to an embodiment of the present disclosure;

FIG. 15 is a circuit diagram of at least one embodiment of a gating circuit in a driving circuit according to an embodiment of the present disclosure;

FIG. 16 is a circuit diagram of at least one embodiment of a gating circuit in a driving circuit according to an embodiment of the present disclosure;

FIG. 17 is a circuit diagram of at least one embodiment of a gating circuit in a driving circuit according to an embodiment of the present disclosure;

FIG. 18 is a circuit diagram of at least one embodiment of a first inversion module;

FIG. 19 is a circuit diagram of at least one embodiment of a second inverting module;

FIG. 20 is a structural diagram of a driving circuit according to at least one embodiment of the present disclosure;

FIG. 21 is a structural diagram of a driving circuit according to at least one embodiment of the present disclosure;

FIG. 22 is a structural diagram of a driving circuit according to at least one embodiment of the present disclosure;

FIG. 23 is a structural diagram of a driving circuit according to at least one embodiment of the present disclosure;

FIG. 24 is a structural diagram of a driving circuit according to at least one embodiment of the present disclosure;

FIG. 25 is a waveform diagram of a control clock signal provided by the control clock signal terminal NCK and a waveform diagram of a first clock signal provided by the first clock signal terminal NCB;

FIG. 26 is a structural diagram of a driving circuit according to at least one embodiment of the present disclosure;

FIG. 27 is a structural diagram of a driving circuit according to at least one embodiment of the present disclosure;

FIG. 28 is a structural diagram of a driving circuit according to at least one embodiment of the present disclosure;

FIG. 29 is a circuit diagram of a driving circuit according to at least one embodiment of the present disclosure;

FIG. 30 is a structural diagram of a driving circuit according to at least one embodiment of the present disclosure;

FIG. 31 is a timing diagram of operation of at least one embodiment of the driving circuit shown in FIG. 30;

FIG. 32 is a timing diagram of the signals output by the output driver terminals of each level; and

FIG. 33 is a circuit diagram of at least one embodiment of a second voltage maintaining circuit.

### DETAILED DESCRIPTION

The following will be combined with the drawings in the embodiments of the present disclosure to clearly and completely describe the technical solutions in the embodiments of the present disclosure. Obviously, the described embodiments are only part of the embodiments of the present disclosure, rather than all the embodiments. Based on the embodiments in the present disclosure, all other embodiments obtained by ordinary technicians in this field without making creative work are within the scope of protection of the present disclosure.

The transistors used in all embodiments of the present disclosure may be thin film transistors or field effect transistors or other devices with the same characteristics. In the embodiments of the present disclosure, in order to distinguish the two electrodes of the transistor except the gate, one of the electrodes is called the first electrode and the other is called the second electrode.

In actual operation, when the transistor is a thin film transistor or a field effect transistor, the first electrode may be a drain electrode, and the second electrode may be a source electrode; or, the first electrode may be a source electrode, and the second electrode may be a drain electrode.

The driving circuit described in the embodiment of the present disclosure includes a driving signal generating circuit, M output driving terminals and M control circuits; the m-th control circuit includes an m-th gating circuit, an m-th output control circuit and an m-th output circuit; M is a positive integer; m is a positive integer less than or equal to M;

The driving signal generating circuit is electrically connected to the control clock signal terminal, the (N−1)-th level driving signal output terminal and the N-th level driving signal output terminal respectively, and is configured to perform a shift operation on the (N−1)-th level driving signal provided by the (N−1)-th level driving signal output terminal under the control of the control clock signal provided by the control clock signal terminal, so as to obtain and output the N-th level driving signal through the N-th level driving signal output terminal.

The m-th gating circuit is electrically connected to the m-th first node, the m-th gating input terminal and the m-th gating control terminal respectively, and is used for controlling the writing of the m-th gating input signal provided by the m-th gating input terminal into the m-th first node under the control of the m-th gating control signal provided by the m-th gating control terminal.

The first terminal of the m-th output control circuit is electrically connected to the N-th level driving signal output end, and the second end of the m-th output control circuit is electrically connected to the m-th first node, and is configured to perform a NAND operation on the N-th level driving signal and the potential of the second end of the m-th output control circuit to obtain the m-th first output signal.

The m-th output circuit is configured to invert the m-th first output signal, and obtain an m-th output driving signal through the m-th output driving terminal.

N is a positive integer.

In the driving circuit described in the embodiment of the present disclosure, one driving signal generating circuit may correspond to at least one control circuit. Under the control of the control clock signal, the driving signal generating circuit performs a shift operation on the (N−1)-th level driving signal to obtain the N-th level driving signal. The m-th control circuit generates the m-th output driving signal based on the N-th level driving signal.

In at least one embodiment of the present disclosure, m is equal to 1 or m is equal to 2 for illustration, but the present invention is not limited thereto. In actual operation, m may also be an integer greater than 2.

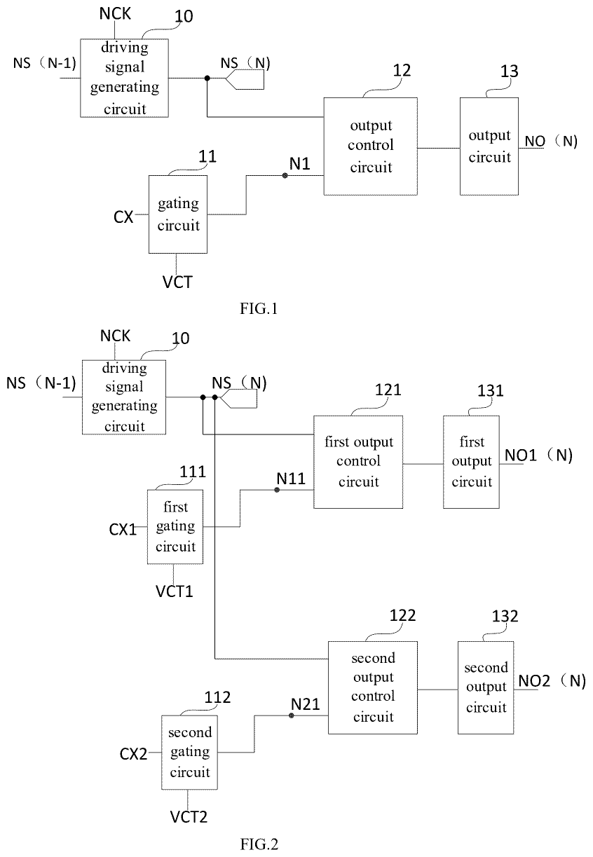

As shown in FIG. 1, the driving circuit according to at least one embodiment of the present disclosure includes a driving signal generating circuit 10, an output driving terminal NO (N) and a control circuit; the control circuit includes a gating circuit 11, an output control circuit 12 and an output circuit 13.

The driving signal generating circuit 10 is electrically connected to the control clock signal terminal NCK, the (N−1)-th level driving signal output terminal NS(N−1) and the N-th level driving signal output terminal NS(N) respectively, and is configured to perform a shift operation on the (N−1)-th level driving signal provided by the (N−1)-th level driving signal output terminal NS(N−1) under the control of the control clock signal provided by the control clock signal terminal NCK, so as to obtain and output the N-th level driving signal through the N-th level driving signal output terminal NS(N).

The gating circuit 11 is electrically connected to the first node N1, the gating input terminal VCT and the gating control terminal CX respectively, and is configured to control the gating input signal provided by the gating input terminal VCT to be written into the first node N1 under the control of the gating control signal provided by the gating control terminal CX.

The first terminal of the output control circuit 12 is electrically connected to the N-th level driving signal output terminal NS (N), and the second end of the output control circuit 12 is electrically connected to the first node N1, and is configured to perform a negative AND operation on the N-th level driving signal and the potential of the second end of the output control circuit 12 to obtain a first output signal.

The output circuit 13 is electrically connected to the output control circuit 12 and the output drive terminal NO (N) respectively, and is configured to invert the first output signal, obtain and provide an output driving signal through the output drive terminal NO (N);

N is a positive integer.

The embodiment of the driving circuit shown in FIG. 1 of the present disclosure may be an N-th stage driving circuit.

When the embodiment of the driving circuit shown in FIG. 1 of the present disclosure is working, within one frame time.

Before the N-th stage driving signal providing stage, the gating circuit 11 writes the gating input signal provided by the gating input terminal VCT into the first node N1 under the control of the gating control signal;

When the selection input signal is a high voltage signal, in the N-th level driving signal providing stage, the N-th level driving signal output terminal NS (N) outputs a high voltage signal, then the first output signal output by the output control circuit 12 is a low voltage signal, and the output circuit 13 provides a high voltage signal through the output drive terminal NO (N), which can control the corresponding row pixel circuit to update the pixel voltage.

When the selection input signal is a low voltage signal, in the N-th level driving signal providing stage, the N-th level driving signal output terminal NS (N) outputs a high voltage signal, then the first output signal output by the output control circuit 12 is a high voltage signal, and the output circuit 13 provides a low voltage signal through the output drive terminal NO (N), which can control the corresponding row pixel circuit not to update the pixel voltage.

At least one embodiment of the present disclosure can realize the update of a partial picture of the display screen by controlling the selection input signal provided by the selection input terminal VCT, thereby reducing power consumption, or realize ultra-low power consumption of OLED (organic light emitting diode) display products such as wearable products, mobile terminals, NB (notebook computers) by partial update of the display picture.

As shown in FIG. 2, the driving circuit according to at least one embodiment of the present disclosure includes a driving signal generating circuit 10, a first output driving terminal NO1 (N), a second output driving terminal NO2 (N), a first control circuit and a second control circuit; the first control circuit includes a first gating circuit 111, a first output control circuit 121 and a first output circuit 131; the second control circuit includes a second gating circuit 112, a second output control circuit 122 and a second output circuit 132.

The driving signal generating circuit 10 is electrically connected to the control clock signal terminal NCK, the (N−1)-th level driving signal output terminal NS(N−1) and the N-th level driving signal output terminal NS(N) respectively, and is configured to perform a shift operation on the (N−1)-th level driving signal provided by the (N−1)-th level driving signal output terminal NS(N−1) under the control of the control clock signal provided by the control clock signal terminal NCK, so as to obtain and output the N-th level driving signal through the N-th level driving signal output terminal NS(N).

The first gating circuit 111 is electrically connected to the first first node N11, the first gating input terminal VCT1 and the first gating control terminal CX1 respectively, and is configured to control the first gating input signal provided by the first gating input terminal VCT1 to be written into the first first node N11 under the control of the first gating control signal provided by the first gating control terminal CX1.

The first terminal of the first output control circuit 121 is electrically connected to the N-th level driving signal output terminal NS (N), and the second end of the first output control circuit 121 is electrically connected to the first first node N11, and is configured to perform a negative AND operation on the N-th level driving signal and the potential of the second end of the first output control circuit 121 to obtain a first first output signal.

The first output circuit 131 is electrically connected to the first output control circuit 121 and the first output driving terminal NO1 (N) respectively, and is configured to invert the first output signal to obtain and provide a first output driving signal through the first output driving terminal NO1 (N).

The second gating circuit 112 is electrically connected to the second first node N21, the second gating input terminal VCT2 and the second gating control terminal CX2 respectively, and is used for controlling the second gating input signal provided by the second gating input terminal VCT2 to be written into the second first node N21 under the control of the second gating control signal provided by the second gating control terminal CX2.

The first terminal of the second output control circuit 122 is electrically connected to the N-th level driving signal output terminal NS (N), and the second end of the second output control circuit 122 is electrically connected to the second first node N21, and is configured to perform a negative AND operation on the N-th level driving signal and the potential of the second end of the second output control circuit 122 to obtain a second first output signal.

The second output circuit 132 is electrically connected to the second output control circuit 122 and the second output drive terminal NO2 (N) respectively, and is configured to invert the second first output signal to obtain and provide a second output driving signal through the second output drive terminal NO2 (N);

N is a positive integer.

The embodiment of the driving circuit shown in FIG. 2 of the present disclosure may be an N-th stage driving circuit.

When the embodiment of the driving circuit shown in FIG. 2 of the present disclosure is working, within one frame time.

Before the N-th stage driving signal providing stage, the first gating circuit 111 writes the first gating input signal provided by the first gating input terminal VCT1 into the first first node N11 under the control of the first gating control signal; the second gating circuit 112 writes the second gating input signal provided by the second gating input terminal VCT2 into the second first node N21 under the control of the second gating control signal;

When the first selection input signal is a high voltage signal, in the N-th level driving signal providing stage, the N-th level driving signal output terminal NS (N) outputs a high voltage signal, then the first output signal output by the first output control circuit 121 is a low voltage signal, and the first output circuit 131 provides a high voltage signal through the first output driving terminal NO1 (N), which can control the corresponding row pixel circuit to update the pixel voltage.

When the first selection input signal is a low voltage signal, in the N-th level driving signal providing stage, the N-th level driving signal output terminal NS (N) outputs a high voltage signal, then the first output signal output by the first output control circuit 121 is a high voltage signal, and the first output circuit 131 provides a low voltage signal through the first output driving terminal NO1 (N), which can control the corresponding row pixel circuit not to update the pixel voltage.

When the second selection input signal is a high voltage signal, in the N-th level driving signal providing stage, the N-th level driving signal output terminal NS (N) outputs a high voltage signal, then the second first output signal output by the second output control circuit 122 is a low voltage signal, and the second output circuit 132 provides a high voltage signal through the second output driving terminal NO2 (N), which can control the corresponding row pixel circuit to update the pixel voltage.

When the second selection input signal is a low voltage signal, in the N-th level driving signal providing stage, the N-th level driving signal output terminal NS (N) outputs a high voltage signal, then the second first output signal output by the second output control circuit 122 is a high voltage signal, and the second output circuit 132 provides a low voltage signal through the second output drive terminal NO2 (N), which can control the corresponding row pixel circuit not to update the pixel voltage.

At least one embodiment of the present disclosure can realize the update of a partial picture of the display screen by controlling the first selection input signal provided by the first selection input terminal VCT1 and the second selection input signal provided by the second selection input terminal VCT2, thereby reducing power consumption, or realize ultra-low power consumption of OLED (organic light emitting diode) display products such as wearable products, mobile terminals, NBs (notebook computers) by partial updating of the display picture.

In at least one embodiment of the present disclosure, the driving circuit further includes a first inverting circuit;

The first inversion circuit is electrically connected to the control clock signal terminal and the inverted clock signal terminal respectively, and is configured to invert the control clock signal to obtain an inverted clock signal, and output the inverted clock signal through the inverted clock signal terminal;

The driving signal generating circuit is also electrically connected to the inverted clock signal terminal, and is also configured to shift the (N−1)-th level driving signal provided by the (N−1)-th level driving signal output terminal under the control of the inverted clock signal, to obtain and output the N-th level driving signal through the N-th level driving signal output terminal.

In a specific implementation, the driving circuit may further include a first inverting circuit, which inverts the control clock signal to obtain an inverted clock signal. The driving signal generating circuit, under the control of the control clock signal and the inverted clock signal, performs a shift operation on the (N−1)-th level driving signal to obtain the N-th level driving signal.

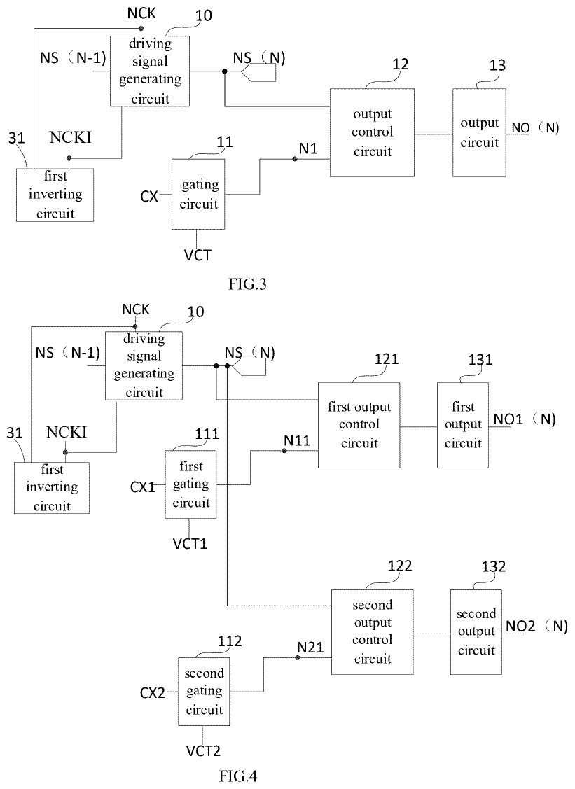

As shown in FIG. 3, based on at least one embodiment of the driving circuit shown in FIG. 1, the driving circuit further includes a first inverting circuit 31.

The first inversion circuit 31 is electrically connected to the control clock signal terminal NCK and the inverted clock signal terminal NCKI respectively, and is configured to invert the control clock signal to obtain an inverted clock signal, and output the inverted clock signal through the inverted clock signal terminal NCKI.

The driving signal generating circuit 10 is also electrically connected to the inverted clock signal terminal NCKI, and is also configured to shift the (N−1)-th level driving signal provided by the (N−1)-th level driving signal output terminal NS (N−1) under the control of the inverted clock signal, to obtain and output the N-th level driving signal through the N-th level driving signal output terminal NS (N).

As shown in FIG. 4, based on at least one embodiment of the driving circuit shown in FIG. 2, the driving circuit further includes a first inverting circuit 31;

The first inversion circuit 31 is electrically connected to the control clock signal terminal NCK and the inverted clock signal terminal NCKI respectively, and is configured to invert the control clock signal to obtain an inverted clock signal, and output the inverted clock signal through the inverted clock signal terminal NCKI.

The driving signal generating circuit 10 is also electrically connected to the inverted clock signal terminal NCKI, and is also configured to shift the (N−1)-th level driving signal provided by the (N−1)-th level driving signal output terminal NS (N−1) under the control of the inverted clock signal, to obtain and output the N-th level driving signal through the N-th level driving signal output terminal NS (N).

As shown in FIG. 5, the related pixel circuit may include a first display control transistor M1, a second display control transistor M2, a driving transistor M3, a fourth display control transistor M4, a fifth display control transistor M5, a sixth display control transistor M6, a seventh display control transistor M7, a storage capacitor Cst and an organic light emitting diode O1.

The gate of M1 is electrically connected to the first reset terminal NR (N), the source of M1 is electrically connected to the initial voltage terminal I1, and the drain of M1 is electrically connected to the gate of M3.

The gate of M2 is electrically connected to the first scanning terminal NG (N), the source of M2 is electrically connected to the gate of M3, and the drain of M2 is electrically connected to the drain of M3.

The gate of M4 is electrically connected to the second scanning terminal PG (N), the source of M4 is electrically connected to the data line D1, and the drain of M4 is electrically connected to the source of M3.

The gate of M5 is electrically connected to the light emitting control terminal E(N), the source of M5 is electrically connected to the power supply voltage terminal ELVDD, and the drain of M5 is electrically connected to the source of M3.

M6 is electrically connected to the light emitting control terminal E (N), the source of M6 is electrically connected to the drain of M3, the drain of M6 is electrically connected to the anode of O1; the cathode of O1 is electrically connected to the low level terminal ELVSS;

The gate of M7 is electrically connected to the second scanning terminal PG(N), the source of M7 is electrically connected to the initial voltage terminal I1, and the drain of M7 is electrically connected to the anode of O1.

In a specific implementation, the first reset terminal NR(N) may be the (N−1)-th stage first scan terminal NG(N), but is not limited thereto.

In the relevant pixel circuit shown in FIG. 5, M1 and M2 are n-type transistors, M3, M4, M5, M6 and M7 are all p-type transistors, M1 and M2 are IGZO (indium gallium zinc oxide) TFTs (thin film transistors) with small leakage current, and M3, M4, M5, M6 and M7 are all LTPS (low temperature polycrystalline silicon) TFTs.

In the relevant pixel circuit shown in FIG. 5, M1 and M2 are IGZO TFTs. When using low-frequency display, the IGZO TFTs can ensure that Cst can maintain the voltage of the gate of M3 for a relatively long time.

In the relevant pixel circuit shown in FIG. 5, the second scanning terminal PG (N) is responsible for resetting the voltage of the anode of O1 and writing the data voltage on the data line into the source of the driving transistor, and the first scanning terminal NG (N) is responsible for resetting Cst, extracting Vth (Vth is the threshold voltage of the driving transistor) and writing the data voltage into the gate of the driving transistor.

In a specific implementation, the first scanning signal provided by the first scanning terminal NG(N) and the second scanning signal provided by the second scanning terminal PG(N) may be in opposite phases to each other, but the present invention is not limited thereto.

The driving circuit described in at least one embodiment of the present disclosure may provide the first scanning terminal NG (N) with the first scanning signal via the output driving terminal NO (N), but the present invention is not limited thereto.

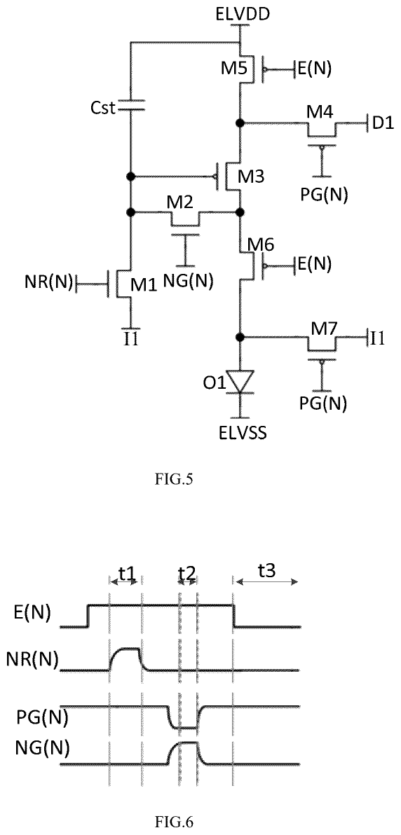

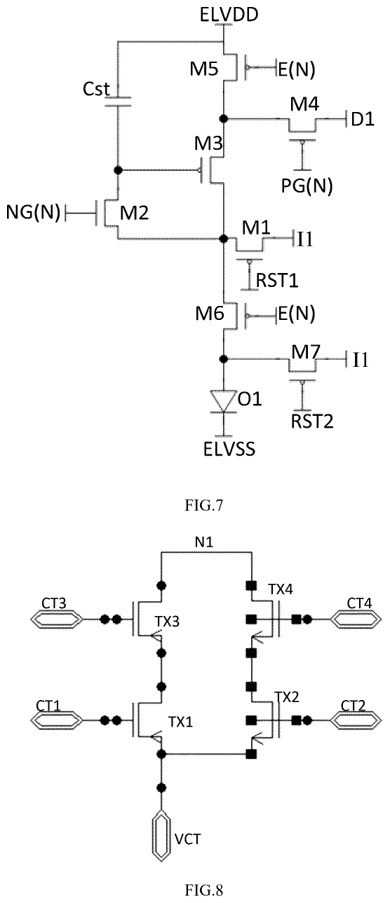

As shown in FIG. 6, when the relevant pixel circuit shown in FIG. 5 is working, the display cycle may include a first display control stage t1, a second display control stage t2, and a third display control stage t3 which are successively arranged;

In the first display control stage t1, E(N) outputs a high voltage signal, NR(N) provides a high voltage signal, PG(N) provides a high voltage signal, NG(N) provides a low voltage signal, M5 and M6 are turned off, M1 is turned on, and the potential of the gate of M3 is pulled down to the initial voltage Vinit; the initial voltage terminal I1 is configured to provide the initial voltage Vinit;

In the second display control stage t2, E(N) outputs a high voltage signal, NR(N) provides a low voltage signal, PG(N) provides a low voltage signal, NG(N) provides a high voltage signal, M5 and M6 are turned off, M1 is turned off, M2 is turned on, M4 is turned on, M2 and M3 form a diode structure, and the data voltage Vdata provided by the data line D1 charges Cst until M3 is turned off. At this time, the gate voltage of M3 is Vdata+Vth, and Vth is the threshold voltage of M3; M7 is turned on to reset the anode voltage of O1;

In the third display control stage t3, E(N) outputs a low voltage signal, NR(N) provides a low voltage signal, PG(N) provides a high voltage signal, NG(N) provides a low voltage signal, M5 and M6 are turned on, M3 drives O1 to emit light; O1 emits light according to the voltage setting of Vdata.

It can be known from the above working process of the relevant pixel circuit that NG (N) can control whether the data voltage Vdata (the data voltage Vdata may be the pixel voltage) is written into the gate of M3 in the second display control stage.

FIG. 7 is a circuit diagram of a related pixel circuit.

As shown in FIG. 7, the related pixel circuit may include a first display control transistor M1, a second display control transistor M2, a driving transistor M3, a fourth display control transistor M4, a fifth display control transistor M5, a sixth display control transistor M6, a seventh display control transistor M7, a storage capacitor Cst and an organic light emitting diode O1.

The gate of M1 is electrically connected to the third reset terminal RST1, the source of M1 is electrically connected to the initial voltage terminal I1, and the drain of M1 is electrically connected to the drain of M3.

The gate of M2 is electrically connected to the first scanning terminal NG (N), the source of M2 is electrically connected to the gate of M3, and the drain of M2 is electrically connected to the drain of M3.

The gate of M4 is electrically connected to the second scanning terminal PG (N), the source of M4 is electrically connected to the data line D1, and the drain of M4 is electrically connected to the source of M3.

The gate of M5 is electrically connected to the light emitting control terminal E(N), the source of M5 is electrically connected to the power supply voltage terminal ELVDD, and the drain of M5 is electrically connected to the source of M3.

The gate of M6 is electrically connected to the light emitting control terminal E (N), the source of M6 is electrically connected to the drain of M3, the drain of M6 is electrically connected to the anode of O1; the cathode of O1 is electrically connected to the low level terminal ELVSS.

The gate of M7 is electrically connected to the fourth reset terminal RST2, the source of M7 is electrically connected to the initial voltage terminal I1, and the drain of M7 is electrically connected to the anode of O1.

When the relevant pixel circuit shown in FIG. 7 is working, NG (N) can control whether the data voltage Vdata on the data line D1 is written into the gate of the driving transistor M3.

In specific implementation, the first scanning signal provided by NG (N) can be configured to control the opening or closing of the second transistor to control whether the data voltage on the data line is written into the gate of the driving transistor, thereby controlling whether the brightness of the pixel circuit of this row is updated; when NG (N) outputs a high voltage signal, the second transistor is turned on, and the brightness of the pixel circuit of this row can be updated; when NG (N) outputs a low voltage signal, the second transistor is always turned off, and the change of the data voltage on the data line will not be written into the gate of the driving transistor, and the luminous brightness of the organic light emitting diode will not change, that is, the display brightness of the pixel circuit of the current row in the current frame remains unchanged. In summary, the pixel brightness can be refreshed by controlling the opening or closing of the N-type transistor. Therefore, when you want to achieve non-refresh of some pixels, just ensure that the N-type transistor is turned off.

Optionally, the m-th gating circuit is configured to control the writing of the m-th selection input signal provided by the m-th selection input terminal into the m-th first node when the potential of the (N−1)-th level driving signal is the first voltage and the potential of the N-th level driving signal is the second voltage.

In a specific implementation, the m-th gating circuit can control the writing of the m-th gating input signal into the m-th first node when the potential of the (N−1)-th level driving signal is the first voltage and the potential of the N-th level driving signal is the second voltage.

Optionally, the first voltage may be a high voltage, and the second voltage may be a low voltage, but the present invention is not limited thereto. In at least one embodiment of the present disclosure, the first voltage may also be a low voltage, and the second voltage may be a high voltage.

Optionally, the m-th gating control terminal includes an m-th first control terminal, an m-th second control terminal, an m-th third control terminal and an m-th fourth control terminal, and the m-th gating circuit includes an m-th first gating transistor, an m-th second gating transistor, an m-th third gating transistor and an m-th fourth gating transistor;

m-th first gating transistor is electrically connected to the m-th first control terminal, and the first electrode of the m-th first gating transistor is electrically connected to the m-th gating input terminal;

The gate of the m-th second gating transistor is electrically connected to the m-th second control terminal, and the first electrode of the m-th second gating transistor is electrically connected to the m-th selection input terminal;

The gate of the m-th third gating transistor is electrically connected to the m-th third control terminal, the first electrode of the m-th third gating transistor is electrically connected to the second electrode of the m-th first gating transistor, and the second electrode of the m-th third gating transistor is electrically connected to the m-th first node;

The gate of the m-th fourth gating transistor is electrically connected to the m-th fourth control terminal, the first electrode of the m-th fourth gating transistor is electrically connected to the second electrode of the m-th second gating transistor, and the second electrode of the m-th fourth gating transistor is electrically connected to the m-th first node;

The m-th first gating transistor is a p-type transistor, the m-th second gating transistor is an n-type transistor, the m-th third gating transistor is a p-type transistor, and the m-th fourth gating transistor is an n-type transistor;

The m-th first control terminal is connected to the inverted signal of the (N−1)-th level driving signal, the m-th second control terminal is the (N−1)-th level driving signal output terminal, the m-th third control terminal is the N-th level driving signal output terminal, and the m-th fourth control terminal is connected to the inverted signal of the N-th level driving signal; or, the m-th first control terminal is connected to the inverted signal of the N-th level driving signal, the m-th second control terminal is the N-th level driving signal output terminal, the m-th third control terminal is the (N−1)-th level driving signal output terminal, and the m-th fourth control terminal is connected to the inverted signal of the (N−1)-th level driving signal.

As shown in FIG. 8, the gating control terminal may include a first control terminal CT1, a second control terminal CT2, a third control terminal CT3, and a fourth control terminal CT4, and at least one embodiment of the gating circuit may include a first gating transistor TX1, a second gating transistor TX2, a third gating transistor TX3, and a fourth gating transistor TX4;

The gate of the first gating transistor TX1 is electrically connected to the first control terminal CT1, and the drain of the first gating transistor TX1 is electrically connected to the selection input terminal VCT;

The gate of the second gating transistor TX2 is electrically connected to the second control terminal CT2, and the drain of the second gating transistor TX2 is electrically connected to the selection input terminal VCT;

The gate of the third gating transistor TX3 is electrically connected to the third control terminal CT3, the drain of the third gating transistor TX3 is electrically connected to the source of the first gating transistor TX1, and the source of the third gating transistor TX3 is electrically connected to the first node N1;

The gate of the fourth gating transistor TX4 is electrically connected to the fourth control terminal CT4, the drain of the fourth gating transistor TX4 is electrically connected to the source of the second gating transistor TX2, and the source of the fourth gating transistor TX4 is electrically connected to the first node N1;

The first gating transistor TX1 is a p-type transistor, the second gating transistor TX2 is an n-type transistor, the third gating transistor TX3 is a p-type transistor, and the fourth gating transistor TX4 is an n-type transistor;

The first control terminal CT1 can be connected to the inverted signal of the (N−1)-th level driving signal, the second control terminal CT2 can be the (N−1)-th level driving signal output terminal, the third control terminal CT3 can be the N-level driving signal output terminal, and the fourth control terminal CT4 can be connected to the inverted signal of the (N−1)-th level driving signal; or, the first control terminal CT1 can be connected to the inverted signal of the (N−1)-th level driving signal, the second control terminal CT2 can be the (N−1)-th level driving signal output terminal, the third control terminal CT3 can be the (N−1)-th level driving signal output terminal, and the fourth control terminal CT4 can be connected to the inverted signal of the (N−1)-th level driving signal.

In at least one embodiment of the present disclosure, the second electrode of the m-th first gating transistor is electrically connected to the second electrode of the m-th second gating transistor.

As shown in FIG. 9, based on at least one embodiment of the gating circuit shown in FIG. 8, the source of the first gating transistor TX1 is electrically connected to the source of the second gating transistor TX2.

Optionally, the m-th gating circuit includes an m-th first gating transistor;

The gate of the m-th first gating transistor is electrically connected to the m-th selection control terminal, the first electrode of the m-th first gating transistor is electrically connected to the m-th first node, and the second electrode of the m-th first gating transistor is electrically connected to the m-th selection input terminal.

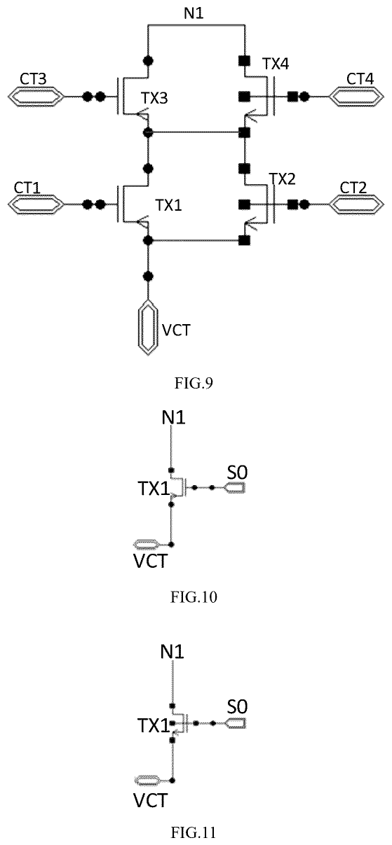

As shown in FIG. 10, at least one embodiment of the gating circuit may include a first gating transistor TX1;

The gate of the first gate transistor TX1 is electrically connected to the gate control terminal S0, the drain of the first gate transistor TX1 is electrically connected to the first node N1, and the source of the first gate transistor TX1 is electrically connected to the gate input terminal VCT;

TX1 is a p-type transistor.

As shown in FIG. 11, at least one embodiment of the gating circuit may include a first gating transistor TX1;

The gate of the first gate transistor TX1 is electrically connected to the gate control terminal S0, the source of the first gate transistor TX1 is electrically connected to the first node N1, and the drain of the first gate transistor TX1 is electrically connected to the gate input terminal VCT;

TX1 is an n-type transistor.

Optionally, the m-th gating control terminal includes an m-th first control terminal and an m-th second control terminal; the m-th gating circuit includes an m-th first gating transistor and an m-th second gating transistor;

The gate of the m-th first gating transistor is electrically connected to the m-th first control terminal, the first electrode of the m-th first gating transistor is electrically connected to the m-th first node, and the second electrode of the m-th first gating transistor is electrically connected to the first electrode of the m-th second gating transistor;

The gate of the m-th second gating transistor is electrically connected to the m-th second control terminal, and the second electrode of the m-th second gating transistor is electrically connected to the m-th selection input terminal;

The m-th first control terminal is the (N−1)-th level driving signal output terminal, the m-th second control terminal is the N-th level driving signal output terminal, the m-th first gating transistor is an n-type transistor, and the m-th second gating transistor is a p-type transistor; or,

The m-th first control terminal is the N-th level driving signal output terminal, the m-th second control terminal is the (N−1)-th level driving signal output terminal, the m-th first gating transistor is a p-type transistor, and the m-th second gating transistor is an n-type transistor; or,

The m-th first control terminal is connected to the inverted signal of the (N−1)-th level driving signal, the m-th second control terminal is the N-th level driving signal output terminal, and the m-th first gating transistor and the m-th second gating transistor are both p-type transistors; or,

The m-th first control terminal is an output terminal of the N-th level driving signal, and the m-th second control terminal is connected to the inverted signal of the (N−1)-th level driving signal; the m-th first gating transistor and the m-th second gating transistor are both p-type transistors; or,

The m-th first control terminal is the (N−1)-th level driving signal terminal, the m-th second control terminal is connected to the inverted signal of the N-th level driving signal, and the m-th first gating transistor and the m-th second gating transistor are both n-type transistors; or,

The m-th first control terminal is connected to the inverted signal of the N-th level driving signal, the m-th second control terminal is the (N−1)-th level driving signal terminal, and the m-th first gating transistor and the m-th second gating transistor are both n-type transistors.

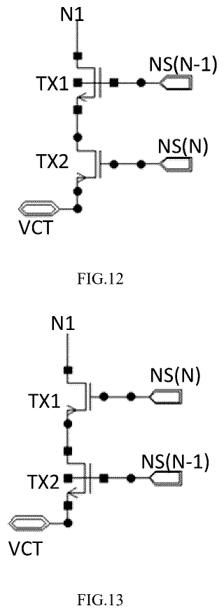

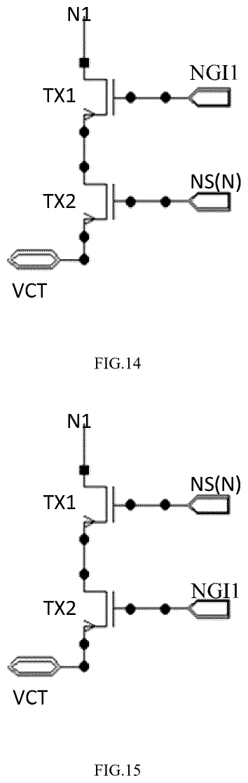

As shown in FIG. 12, at least one embodiment of the gating circuit may include a first gating transistor TX1 and a second gating transistor TX2;

The gate of the first gating transistor TX1 is electrically connected to the (N−1)-th stage driving signal output terminal NS(N−1), the source of the first gating transistor TX1 is electrically connected to the first node N1, and the drain of the first gating transistor TX1 is electrically connected to the drain of the second gating transistor TX2;

The gate of the second gating transistor TX2 is electrically connected to the N-th stage driving signal output terminal NS(N), and the source of the second gating transistor TX2 is electrically connected to the selection input terminal VCT;

TX1 is an n-type transistor and TX2 is a p-type transistor.

As shown in FIG. 13, at least one embodiment of the gating circuit may include a first gating transistor TX1 and a second gating transistor TX2;

The gate of the first gating transistor TX1 is electrically connected to the N-th stage driving signal output terminal NS (N), the drain of the first gating transistor TX1 is electrically connected to the first node N1, and the source of the first gating transistor TX1 is electrically connected to the source of the second gating transistor T2;

The gate of the second gating transistor TX2 is electrically connected to the (N−1)-th stage driving signal output terminal NS(N−1), and the drain of the second gating transistor TX2 is electrically connected to the selection input terminal VCT;

TX1 is a p-type transistor and TX2 is an n-type transistor.

As shown in FIG. 14, at least one embodiment of the gating circuit may include a first gating transistor TX1 and a second gating transistor TX2;

The gate of the first gate transistor TX1 is electrically connected to the first inverted driving signal terminal NGI1, the drain of the first gate transistor TX1 is electrically connected to the first node N1, and the source of the first gate transistor TX1 is electrically connected to the drain of the second gate transistor TX2; the first inverted driving signal provided by the first inverted driving signal terminal NGI1 is inverted with the (N−1)-th level driving signal provided by the (N−1)-th level driving signal output terminal NS (N−1);
the second gating transistor TX2 is electrically connected to the N-th stage driving signal output terminal NS(N), and the source of the second gating transistor TX2 is electrically connected to the selection input terminal VCT;

TX1 is a p-type transistor, and TX2 is a p-type transistor.

As shown in FIG. 15, at least one embodiment of the gating circuit may include a first transistor TX1 and a second transistor TX2;

The gate of the first pass transistor TX1 is electrically connected to the N-th stage driving signal output terminal NS (N), the drain of the first pass transistor TX1 is electrically connected to the first node N1, and the source of the first pass transistor TX1 is electrically connected to the drain of the second pass transistor TX2;

The gate of the second gate transistor TX2 is electrically connected to the first inverted driving signal terminal NGI1, and the source of the second gate transistor TX2 is electrically connected to the gate input terminal VCT; the first inverted driving signal provided by the first inverted driving signal terminal NGI1 is inverted with the (N−1)-th level driving signal provided by the (N−1)-th level driving signal output terminal NS(N−1);

TX1 is a p-type transistor, and TX2 is a p-type transistor.

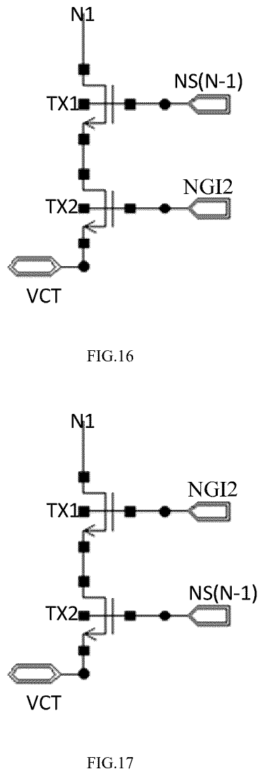

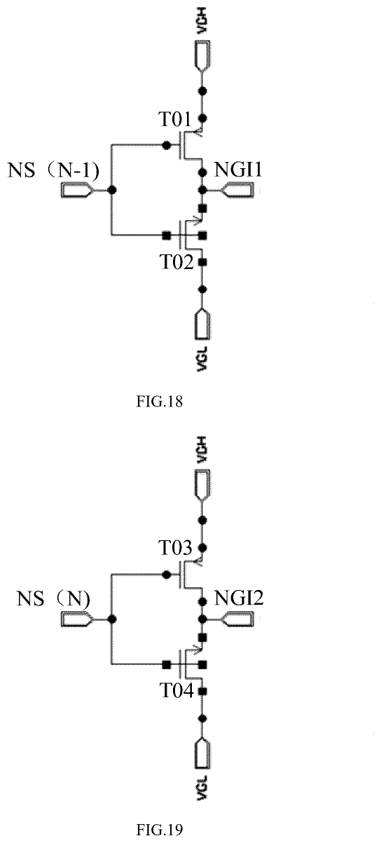

As shown in FIG. 16, at least one embodiment of the gating circuit may include a first gating transistor TX1 and a second gating transistor TX2;

The gate of the first gating transistor TX1 is electrically connected to the (N−1)-th stage driving signal output terminal NS(N−1), the source of the first gating transistor TX1 is electrically connected to the first node N1, and the drain of the first gating transistor TX1 is electrically connected to the source of the second gating transistor TX2;

The gate of the second gate transistor TX2 is electrically connected to the second inverted driving signal terminal NGI2, and the drain of the second gate transistor TX2 is electrically connected to the gate input terminal VCT; the second inverted driving signal provided by the second inverted driving signal terminal NGI2 is inverted with the N-th level driving signal provided by the N-th level driving signal output terminal NS(N);

TX1 is an n-type transistor, and TX2 is an n-type transistor.

As shown in FIG. 17, at least one embodiment of the gating circuit may include a first gating transistor TX1 and a second gating transistor TX2;

The gate of the first gate transistor TX1 is electrically connected to the second inverted driving signal terminal NGI2, the source of the first gate transistor TX1 is electrically connected to the first node N1, and the drain of the first gate transistor TX1 is electrically connected to the source of the second gate transistor TX2; the second inverted driving signal provided by the second inverted driving signal terminal NGI2 is inverted with the N-th level driving signal provided by the N-th level driving signal output terminal NS(N);

The gate of the second gating transistor TX2 is electrically connected to the (N−1)-th stage driving signal output terminal NS(N−1), and the drain of the second gating transistor TX2 is electrically connected to the selection input terminal VCT;

TX1 is an n-type transistor, and TX2 is an n-type transistor.

As shown in FIG. 18, the (N−1)-th level driving signal provided by the (N−1)-th level driving signal output terminal NS(N−1) can be inverted by the first inversion module to obtain a first inverted driving signal provided by the first inverted driving signal terminal NGI1;

The first inverting module includes a first inverting control transistor T01 and a second inverting control transistor T02;

T01 is a p-type transistor, and T02 is an n-type transistor.

As shown in FIG. 19, the N-th level driving signal provided by the N-th level driving signal output terminal NS(N) may be inverted by the second inversion module to obtain a second inverted driving signal provided by the second inverted driving signal terminal NGI2;

The second inverting module includes a third inverting control transistor T03 and a fourth inverting control transistor T04;

T03 is a p-type transistor, and T04 is an n-type transistor.

In at least one embodiment of the present disclosure, the m-th control circuit further includes an m-th first initialization circuit;

The m-th first initialization circuit is electrically connected to the initial control terminal, the first voltage terminal and the m-th first node respectively, and is configured to control the connection between the m-th first node and the first voltage terminal under the control of the initial control signal provided by the initial control terminal.

In a specific implementation, the m-th control circuit may further include an m-th first initialization circuit, and the m-th first initialization circuit controls the connection between the m-th first node and the first voltage terminal under the control of an initial control signal.

In at least one embodiment of the present disclosure, the first voltage terminal may be a high voltage terminal, but is not limited thereto.

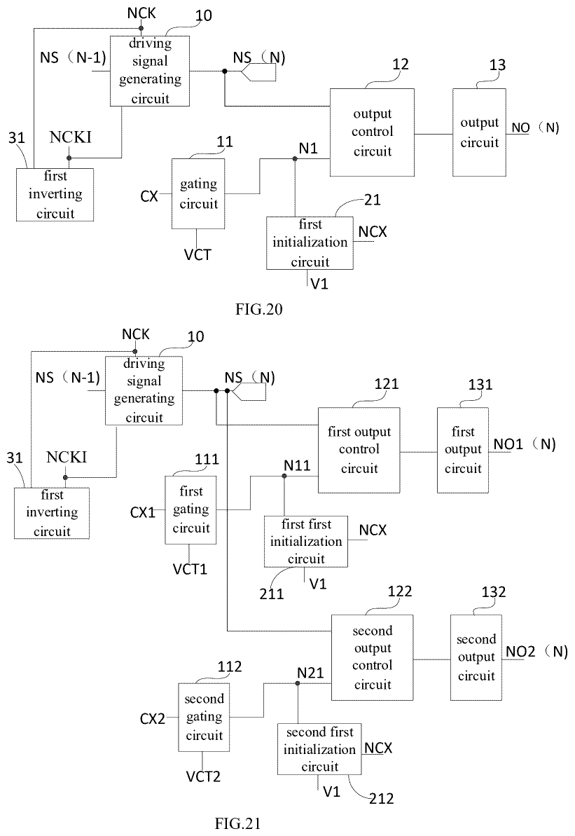

As shown in FIG. 20, based on at least one embodiment of the driving circuit shown in FIG. 3, the control circuit may further include a first initialization circuit 21;

The first initialization circuit 21 is electrically connected to the initial control terminal NCX, the first voltage terminal V1 and the first node N1 respectively, and is configured to control the connection between the first node N1 and the first voltage terminal V1 under the control of the initial control signal provided by the initial control terminal NCX.

When at least one embodiment of the driving circuit shown in FIG. 20 is in operation, at the beginning of a frame time, NCX provides a valid voltage signal, and the first initialization circuit 21 controls the connection between the first node N1 and the first voltage terminal V1.

As shown in FIG. 21, based on at least one embodiment of the driving circuit shown in FIG. 4, the first control circuit may further include a first first initialization circuit 211, and the second control circuit may further include a second first initialization circuit 212;

The first first initialization circuit 211 is electrically connected to the initial control terminal NCX, the first voltage terminal V1 and the first first node N11 respectively, and is configured to control the connection between the first first node N11 and the first voltage terminal V1 under the control of the initial control signal provided by the initial control terminal NCX;

The second first initialization circuit 212 is electrically connected to the initial control terminal NCX, the first voltage terminal V1 and the second first node N21 respectively, and is configured to control the connection between the second first node N21 and the first voltage terminal V1 under the control of the initial control signal provided by the initial control terminal NCX.

In at least one embodiment of the present disclosure, the m-th control circuit further includes an m-th reset circuit;

The m-th reset circuit is electrically connected to the first voltage terminal, the (N−1)-th level driving signal output terminal, the (N−1)-th level driving signal output terminal and the m-th first node, respectively, and is configured to control the connection between the m-th first node and the first voltage terminal under the control of the (N−1)-th level driving signal and the (N−1)-th level driving signal provided by the (N−1)-th level driving signal output terminal.

In a specific implementation, the m-th control circuit may further include an m-th reset circuit, which, under the control of the N-th level driving signal and the (N−1)-th level driving signal, resets the potential of the m-th first node after the m-th output circuit provides the m-th output driving signal through the m-th output drive terminal.

In at least one embodiment of the present disclosure, the m-th control circuit further includes an m-th first voltage maintaining circuit;

m-th first voltage maintaining circuit is electrically connected to the m-th first node, the second end of the m-th first voltage maintaining circuit is electrically connected to the DC voltage end, and the m-th voltage maintaining circuit is configured to maintain the potential of the m-th first node.

In a specific implementation, the m-th control circuit may further include an m-th first voltage maintaining circuit, and the m-th first voltage maintaining circuit may be configured to maintain the potential of the m-th first node.

Optionally, the DC voltage terminal may be a first voltage terminal, a second voltage terminal or a third voltage terminal, but is not limited thereto.

In at least one embodiment of the present disclosure, the first voltage terminal may be a high voltage terminal, the second voltage terminal may be a first low voltage terminal, and the third voltage terminal may be a second low voltage terminal, but the present invention is not limited thereto.

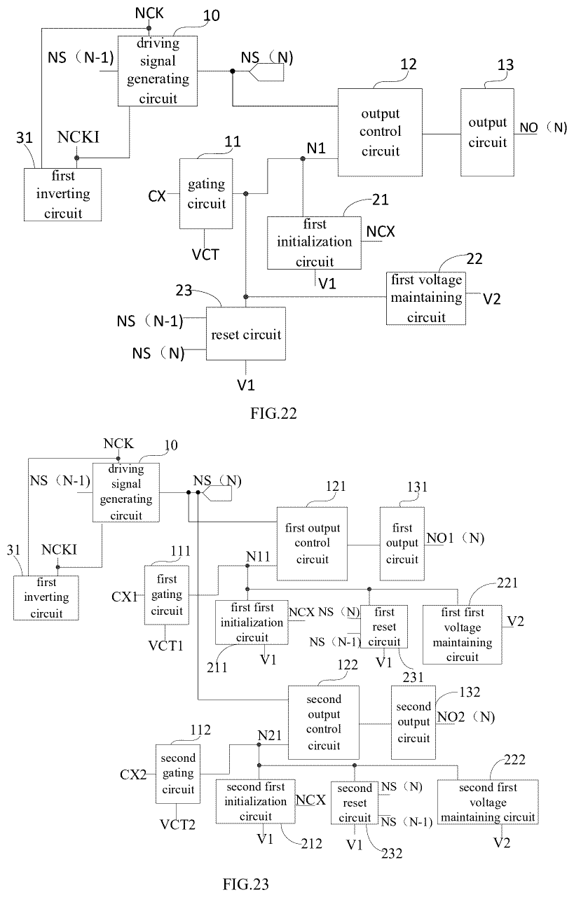

As shown in FIG. 22, based on at least one embodiment of the driving circuit shown in FIG. 20, the control circuit may further include a first voltage maintaining circuit 22 and a reset circuit 23;

The reset circuit 23 is electrically connected to the first voltage terminal V1, the N−1-th level driving signal output terminal NS(N−1), the N-th level driving signal output terminal NS(N) and the first node N1 respectively, and is configured to control the first node N1 to be connected to the first voltage terminal V1 under the control of the N−1-th level driving signal and the N−1-th level driving signal provided by the N−1-th level driving signal output terminal NS(N−1);

A first terminal of the first voltage maintaining circuit 22 is electrically connected to the first node N1, a second end of the first voltage maintaining circuit 22 is electrically connected to a second voltage terminal V2, and the first voltage maintaining circuit 22 is configured to maintain the potential of the first node N1.

As shown in FIG. 23, based on at least one embodiment of the driving circuit shown in FIG. 21, the first control circuit may further include a first first voltage maintaining circuit 221 and a first reset circuit 231; the second control circuit may further include a second first voltage maintaining circuit 222 and a second reset circuit 232;

The first reset circuit 231 is electrically connected to the first voltage terminal V1, the N−1-th level driving signal output terminal NS(N−1), the N-th level driving signal output terminal NS(N) and the first first node N11 respectively, and is configured to control the connection between the first first node N11 and the first voltage terminal V1 under the control of the N−1-th level driving signal and the N−1-th level driving signal provided by the N−1-th level driving signal output terminal NS(N−1);

The first terminal of the first first voltage maintaining circuit 221 is electrically connected to the first first node N11, the second end of the first first voltage maintaining circuit 221 is electrically connected to the second voltage terminal V2, and the first first voltage maintaining circuit 221 is configured to maintain the potential of the first first node N11;

The second reset circuit 232 is electrically connected to the first voltage terminal V1, the N−1-th level driving signal output terminal NS(N−1), the N-th level driving signal output terminal NS(N) and the second first node N21 respectively, and is configured to control the second first node N21 to be connected to the first voltage terminal V1 under the control of the N−1-th level driving signal and the N−1-th level driving signal provided by the N−1-th level driving signal output terminal NS(N−1);

The first terminal of the second first voltage maintaining circuit 222 is electrically connected to the second first node N21, the second end of the second first voltage maintaining circuit 222 is electrically connected to the second voltage terminal V2, and the second first voltage maintaining circuit 222 is configured to maintain the potential of the second first node N21.

Optionally, the m-th control circuit further includes an m-th second voltage maintaining circuit; the m-th first node is electrically connected to the second end of the m-th output control circuit through the m-th second voltage maintaining circuit;

The m-th second voltage maintaining circuit comprises an m-th first inverter, an m-th second inverter and an m-th maintaining control circuit;

The input end of the m-th first inverter is electrically connected to the m-th first node, the output end of the m-th first inverter is electrically connected to the m-th second node, the input end of the m-th second inverter is electrically connected to the m-th second node, and the output end of the m-th second inverter is electrically connected to the m-th third node and the second end of the m-th output control circuit;

The m-th first inverter is configured to invert the potential of the m-th first node, and output the inverted potential of the m-th first node through the output end of the m-th first inverter, and the m-th second inverter is configured to invert the potential of its input end, and output the inverted potential through the output end of the m-th second inverter;

The m-th maintaining control circuit is electrically connected to the m-th maintaining control terminal, the m-th third node and the m-th first node respectively, and is configured to control the connection or disconnection between the m-th third node and the m-th first node under the control of the m-th maintaining control signal provided by the m-th maintaining control terminal.

In a specific implementation, the m-th control circuit may further include an m-th second voltage maintaining circuit, the m-th first node may be electrically connected to the second end of the m-th output control circuit through the m-th second voltage maintaining circuit, and the m-th second voltage maintaining circuit may include an m-th first inverter, an m-th second inverter and an m-th maintaining control circuit; the m-th first inverter inverts the potential of the m-th first node, and the m-th second inverter inverts the potential of its input end; the m-th maintaining control circuit controls the connection or disconnection between the m-th third node and the m-th first node under the control of the maintaining control signal provided by the m-th maintaining control end;

The m-th maintaining control circuit may control the m-th third node to be disconnected from the m-th first node when the m-th gating circuit controls the m-th gating input signal to be written into the m-th first node.

When the driving circuit described in at least one embodiment of the present disclosure is in operation, by adding an m-th second voltage maintaining circuit, the m-th first inverter and the m-th second inverter included in the m-th second voltage maintaining circuit can control the connection between the m-th third node and the high voltage end when the potential of the m-th first node is a high voltage, so that the potential of the m-th third node can be higher than the potential of the m-th first node, and can control the connection between the m-th third node and the low voltage end when the potential of the m-th first node is a low voltage, so that the potential of the m-th third node can be lower than the potential of the m-th first node, so that the m-th third node can better control the transistor whose gate is electrically connected to the m-th third node included in the m-th output control circuit.

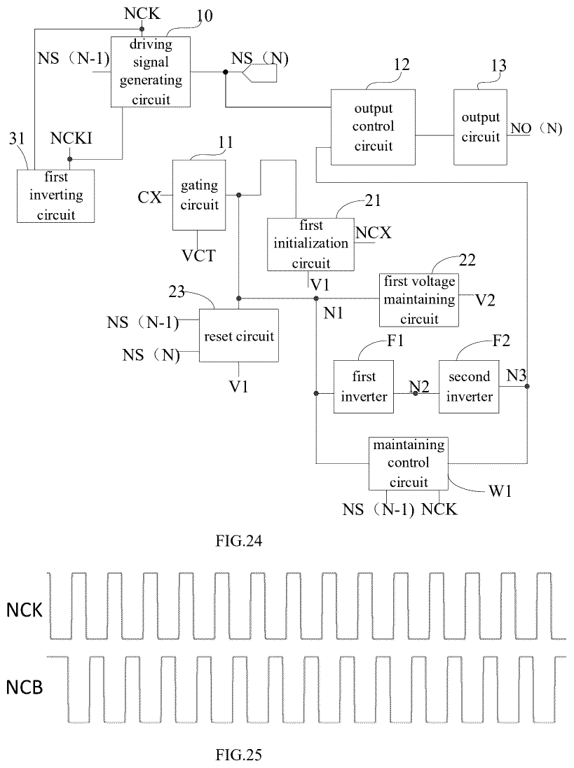

As shown in FIG. 24, based on at least one embodiment of the driving circuit shown in FIG. 22, the control circuit may further include a second voltage maintaining circuit; the maintaining control terminal includes the N−1-th level driving signal output terminal NS (N−1) and the control clock signal terminal NCK; the first node N1 is electrically connected to the second terminal of the output control circuit 12 through the second voltage maintaining circuit;

The second voltage maintaining circuit includes a first inverter F1, a second inverter F2 and a maintaining control circuit W1;
the first inverter F1 is electrically connected to the first node N1, and the output end of the first inverter F1 is electrically connected to the second node N2;

The input end of the second inverter F2 is electrically connected to the second node N2, and the output end of the second inverter F2 is electrically connected to the third node N3 and the second end of the output control circuit 12;

The first inverter F1 is configured to invert the potential of the first node N1, and output the inverted potential of the first node N1 through the output end of the first inverter F1;

The second inverter F2 is configured to invert the potential at its input terminal and output the inverted potential through the output terminal of the second inverter F2;

The maintaining control circuit W1 is electrically connected to the (N−1)-th level driving signal output terminal NS (N−1), the control clock signal terminal NCK, the third node N3 and the first node N1, respectively, and is configured to control the connection or disconnection between the third node N3 and the first node N1 under the control of the (N−1)-th level driving signal provided by the (N−1)-th level driving signal output terminal NS (N−1), and to control the connection or disconnection between the third node N3 and the first node N1 under the control of the control clock signal provided by the control clock signal terminal NCK.

In at least one embodiment shown in FIG. 24, the (N−1)-th stage driving signal output terminal may be replaced by an inverted clock signal terminal or a first clock signal terminal, but is not limited thereto.

FIG. 25 shows the waveform of the control clock signal provided by the control clock signal terminal NCK and the waveform of the first clock signal provided by the first clock signal terminal NCB.

In at least one embodiment of the present disclosure, the driving signal generating circuit includes a first driving control circuit, a second driving control circuit, a second inverting circuit, and a second initialization circuit;

The first driving control circuit is electrically connected to the control clock signal terminal, the inverted clock signal terminal, the (N−1)-th level driving signal output terminal and the fourth node respectively, and is configured to shift and invert the (N−1)-th driving signal provided by the (N−1)-th level driving signal output terminal under the control of the control clock signal provided by the control clock signal terminal and the inverted clock signal provided by the inverted clock signal terminal, and obtain and output the inverted signal through the fourth node;

The second driving control circuit is electrically connected to the control clock signal terminal, the inverted clock signal terminal, the N-th level driving signal output terminal and the fourth node respectively, and is configured to invert the N-th level driving signal provided by the N-th level driving signal output terminal under the control of the control clock signal and the inverted clock signal, and obtain and output the inverted signal through the fourth node;

The second inverting circuit is electrically connected to the fourth node and the N-th level driving signal output terminal respectively, and is configured to invert the potential of the fourth node and output the inverted signal through the N-th level driving signal output terminal;

The second initialization circuit is electrically connected to the initial control terminal, the first voltage terminal and the N-th level driving signal output terminal respectively, and is configured to control the connection between the N-th level driving signal output terminal and the first voltage terminal under the control of the initial control signal provided by the initial control terminal.

In at least one embodiment of the present disclosure, when M is equal to 1, the control circuit may include a first voltage maintaining circuit and/or a second voltage maintaining circuit to maintain the potential of the first node;

When M is greater than 1, the m-th control circuit may include an m-th first voltage maintaining circuit and/or an m-th second voltage maintaining circuit to maintain the potential of the m-th first node.

Optionally, the m-th reset circuit includes an m-th first transistor and an m-th second transistor;

The gate of the m-th first transistor is electrically connected to the (N−1)-th stage driving signal output terminal, the first electrode of the m-th first transistor is electrically connected to the first voltage terminal, and the second electrode of the m-th first transistor is electrically connected to the first electrode of the m-th second transistor;

The gate of the m-th second transistor is electrically connected to the N-th stage driving signal output terminal, and the second electrode of the m-th second transistor is electrically connected to the m-th first node.

Optionally, the m-th maintaining control terminal includes an m-th first maintaining control terminal and an m-th second maintaining control terminal;

The m-th maintaining control circuit comprises an m-th third transistor and an m-th fourth transistor;

The gate of the m-th third transistor is electrically connected to the m-th first maintaining control terminal, the first electrode of the m-th third transistor is electrically connected to the m-th first node, and the second electrode of the m-th third transistor is electrically connected to the m-th third node;

The gate of the m-th fourth transistor is electrically connected to the m-th second maintaining control terminal, the first electrode of the m-th fourth transistor is electrically connected to the m-th third node, and the second electrode of the m-th fourth transistor is electrically connected to the m-th first node;

The m-th third transistor is a p-type transistor, and the m-th fourth transistor is an n-type transistor;

The m-th first maintaining control terminal is the (N−1)-th level driving signal terminal, and the m-th second maintaining control terminal is the control clock signal terminal; or,

The m-th first maintaining control terminal is an inverted clock signal terminal, and the m-th second maintaining control terminal is a control clock signal terminal.

Optionally, the m-th first inverter includes an m-th fifth transistor and an m-th sixth transistor, and the m-th second inverter includes an m-th seventh transistor and an m-th eighth transistor;

The gate of the m-th fifth transistor is electrically connected to the m-th first node, the first electrode of the m-th fifth transistor is electrically connected to the first voltage terminal, and the second electrode of the m-th fifth transistor is electrically connected to the m-th second node;

The gate of the m-th sixth transistor is electrically connected to the m-th first node, the first electrode of the m-th sixth transistor is electrically connected to the m-th second node, and the second electrode of the m-th sixth transistor is electrically connected to the second voltage terminal;

The m-th fifth transistor is a p-type transistor, and the m-th sixth transistor is an n-type transistor;

A gate of the m-th seventh transistor is electrically connected to the m-th second node, a first electrode of the m-th seventh transistor is electrically connected to the first voltage terminal, and a second electrode of the m-th seventh transistor is electrically connected to the m-th third node;

The gate of the m-th eighth transistor is electrically connected to the m-th second node, the first electrode of the m-th eighth transistor is electrically connected to the m-th third node, and the second electrode of the m-th eighth transistor is electrically connected to the second voltage terminal;

The m-th seventh transistor is a p-type transistor, and the m-th eighth transistor is an n-type transistor.

Optionally, the m-th first initialization circuit includes an m-th ninth transistor;

The gate of the m-th ninth transistor is electrically connected to the initial control terminal, the first electrode of the m-th ninth transistor is electrically connected to the first voltage terminal, and the second electrode of the m-th ninth transistor is electrically connected to the m-th first node.

Optionally, the m-th first voltage maintaining circuit includes an m-th capacitor;

The first terminal of the m-th capacitor is electrically connected to the m-th first node, and the second end of the m-th capacitor is electrically connected to a DC voltage terminal.

Optionally, the m-th output control circuit includes an m-th tenth transistor, an m-th eleventh transistor, an m-th twelfth transistor and an m-th thirteenth transistor;

The gate of the m-th tenth transistor is electrically connected to the m-th first node, the first electrode of the m-th tenth transistor is electrically connected to the first voltage terminal, and the second electrode of the m-th tenth transistor is electrically connected to the m-th second node;

The gate of the m-th eleventh transistor is electrically connected to the N-th stage driving signal output terminal, the first electrode of the m-th eleventh transistor is electrically connected to the first voltage terminal, and the second electrode of the m-th eleventh transistor is electrically connected to the m-th second node;

A gate of the m-th twelfth transistor is electrically connected to the m-th first node, a first electrode of the m-th twelfth transistor is electrically connected to the m-th second node, and a second electrode of the m-th twelfth transistor is electrically connected to a first electrode of the m-th thirteenth transistor;

The gate of the m-th thirteenth transistor is electrically connected to the N-level driving signal output terminal, and the second electrode of the m-th thirteenth transistor is electrically connected to the second voltage terminal;

The m-th tenth transistor and the m-th eleventh transistor are p-type transistors, and the m-th twelfth transistor and the m-th thirteenth transistor are n-type transistors.

Optionally, the m-th output circuit includes an m-th fourteenth transistor and an m-th fifteenth transistor;

The gate of the m-th fourteenth transistor is electrically connected to the m-th second node, the first electrode of the m-th fourteenth transistor is electrically connected to the first voltage terminal, and the second electrode of the m-th fourteenth transistor is electrically connected to the m-th output driving terminal;

The gate of the m-th fifteenth transistor is electrically connected to the m-th second node, the first electrode of the m-th fifteenth transistor is electrically connected to the m-th output driving terminal, and the second electrode of the m-th fifteenth transistor is electrically connected to the second voltage terminal.

In at least one embodiment of the present disclosure, the driving signal generating circuit includes a first driving control circuit, a second driving control circuit, a second inverting circuit, and a second initialization circuit;

The first driving control circuit is electrically connected to the control clock signal terminal, the inverted clock signal terminal, the (N−1)-th level driving signal output terminal and the fourth node respectively, and is configured to shift and invert the (N−1)-th driving signal provided by the (N−1)-th level driving signal output terminal under the control of the control clock signal provided by the control clock signal terminal and the inverted clock signal provided by the inverted clock signal terminal, and obtain and output the inverted signal through the fourth node;

The second driving control circuit is electrically connected to the control clock signal terminal, the inverted clock signal terminal, the N-th level driving signal output terminal and the fourth node respectively, and is configured to invert the N-th level driving signal provided by the N-th level driving signal output terminal under the control of the control clock signal and the inverted clock signal, and obtain and output the inverted signal through the fourth node;

The second inverting circuit is electrically connected to the fourth node and the N-th level driving signal output terminal respectively, and is configured to invert the potential of the fourth node and output the inverted signal through the N-th level driving signal output terminal;

The second initialization circuit is electrically connected to the initial control terminal, the first voltage terminal and the N-th level driving signal output terminal respectively, and is configured to control the connection between the N-th level driving signal output terminal and the first voltage terminal under the control of the initial control signal provided by the initial control terminal.

In a specific implementation, the driving signal generating circuit may include a first driving control circuit, a second driving control circuit, a second inverting circuit and a second initialization circuit; the first driving control circuit shifts and inverts the (N−1)-th driving signal under the control of a control clock signal and an inverted clock signal, and outputs the inverted signal through a fourth node; the second driving control circuit inverts the N-th level driving signal under the control of a control clock signal and an inverted clock signal, and outputs the inverted signal through a fourth node; the second inverting circuit inverts the potential of the fourth node, and outputs the inverted signal through an N-th level driving signal output terminal; the second initialization circuit controls the connection between the N-th level driving signal output terminal and the first voltage terminal under the control of the initial control signal.

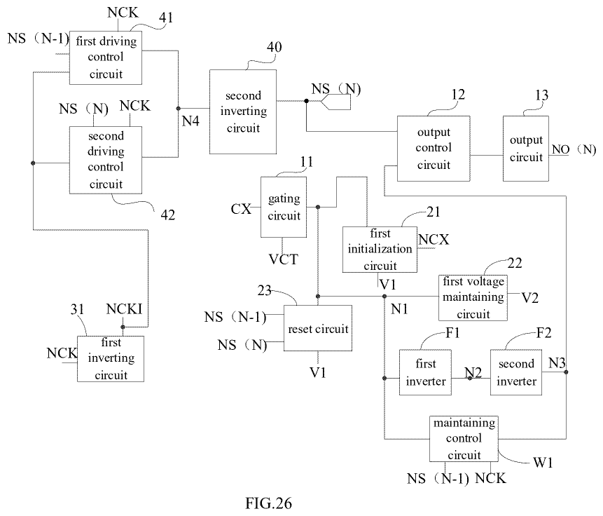

As shown in FIG. 26, based on at least one embodiment of the driving circuit shown in FIG. 24, the driving signal generating circuit may include a first driving control circuit 41, a second driving control circuit 42, a second inverting circuit 44 and a second initialization circuit 40;

The first driving control circuit 41 is electrically connected to the control clock signal terminal NCK, the inverted clock signal terminal NCKI, the (N−1)-th level driving signal output terminal NS(N−1) and the fourth node N4 respectively, and is configured to shift and invert the (N−1)-th driving signal provided by the (N−1)-th level driving signal output terminal NS(N−1) under the control of the control clock signal provided by the control clock signal terminal NCK and the inverted clock signal provided by the inverted clock signal terminal NCKI, and obtain and output the inverted signal through the fourth node N4;

The second driving control circuit 42 is electrically connected to the control clock signal terminal NCK, the inverted clock signal terminal NCKI, the N-th level driving signal output terminal NS(N) and the fourth node N4 respectively, and is configured to invert the N-th level driving signal provided by the N-th level driving signal output terminal NS(N) under the control of the control clock signal and the inverted clock signal, and obtain and output the inverted signal through the fourth node N4;

The second inverting circuit 44 is electrically connected to the fourth node N4 and the N-th stage driving signal output terminal NS(N) respectively, and is configured to invert the potential of the fourth node N4 and output the inverted signal through the N-th stage driving signal output terminal NS(N);

The second initialization circuit 40 is electrically connected to the initial control terminal NCX, the first voltage terminal V1 and the N-th level driving signal output terminal NS(N), respectively, and is configured to control the connection between the N-th level driving signal output terminal NS(N) and the first voltage terminal V1 under the control of the initial control signal provided by the initial control terminal NCX.

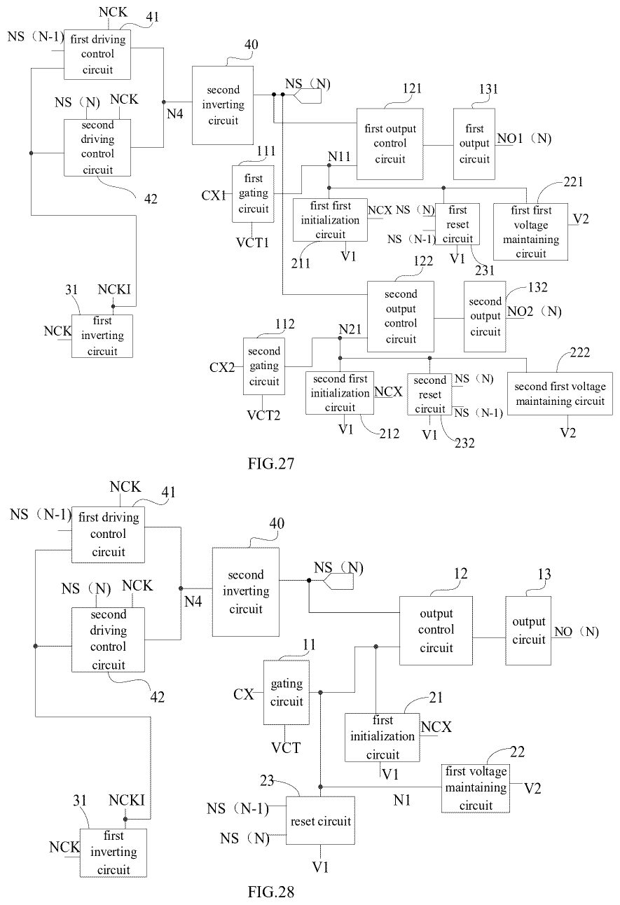

As shown in FIG. 27, based on at least one embodiment of the driving circuit shown in FIG. 23, the driving signal generating circuit may include a first driving control circuit 41, a second driving control circuit 42, a second inverting circuit 44 and a second initialization circuit 40;

The first driving control circuit 41 is electrically connected to the control clock signal terminal NCK, the inverted clock signal terminal NCKI, the (N−1)-th stage driving signal output terminal NS(N−1) and the fourth node N4 respectively, and is configured to shift and invert the (N−1)-th driving signal provided by the (N−1)-th stage driving signal output terminal NS(N−1) under the control of the control clock signal provided by the control clock signal terminal NCK and the inverted clock signal provided by the inverted clock signal terminal NCKI, and obtain and output the inverted signal through the fourth node N4;

The second driving control circuit 42 is electrically connected to the control clock signal terminal NCK, the inverted clock signal terminal NCKI, the N-th level driving signal output terminal NS(N) and the fourth node N4 respectively, and is configured to invert the N-th level driving signal provided by the N-th level driving signal output terminal NS(N) under the control of the control clock signal and the inverted clock signal, and obtain and output the inverted signal through the fourth node N4;

The second inverting circuit 44 is electrically connected to the fourth node N4 and the N-th stage driving signal output terminal NS(N) respectively, and is configured to invert the potential of the fourth node N4 and output the inverted signal through the N-th stage driving signal output terminal NS(N);

The second initialization circuit 40 is electrically connected to the initial control terminal NCX, the first voltage terminal V1 and the N-th level driving signal output terminal NS(N), respectively, and is configured to control the connection between the N-th level driving signal output terminal NS(N) and the first voltage terminal V1 under the control of the initial control signal provided by the initial control terminal NCX.

The difference between at least one embodiment of the driving circuit shown in FIG. 28 and at least one embodiment of the driving circuit shown in FIG. 26 is that the second voltage maintaining circuit is not included.

Optionally, the first driving control circuit includes a sixteenth transistor, a seventeenth transistor, an eighteenth transistor and a nineteenth transistor;

The gate of the sixteenth transistor is electrically connected to the inverted clock signal terminal, the first electrode of the sixteenth transistor is electrically connected to the first voltage terminal, and the second electrode of the sixteenth transistor is electrically connected to the first electrode of the seventeenth transistor;

The gate of the seventeenth transistor is electrically connected to the (N−1)-th stage driving signal output terminal, and the second electrode of the seventeenth transistor is electrically connected to the fourth node;

The gate of the eighteenth transistor is electrically connected to the (N−1)-th stage driving signal output terminal, the first electrode of the eighteenth transistor is electrically connected to the fourth node, and the second electrode of the eighteenth transistor is electrically connected to the first electrode of the nineteenth transistor;

The gate of the nineteenth transistor is electrically connected to the control clock signal terminal, and the second electrode of the nineteenth transistor is electrically connected to the third voltage terminal;

The sixteenth transistor and the seventeenth transistor are p-type transistors, and the eighteenth transistor and the nineteenth transistor are n-type transistors.

Optionally, the second driving control circuit includes a twentieth transistor, a twenty-first transistor, a twenty-second transistor and a twenty-third transistor;

The gate of the twentieth transistor is electrically connected to the N-th stage driving signal output terminal, the first electrode of the twentieth transistor is electrically connected to the first voltage terminal, and the second electrode of the twentieth transistor is electrically connected to the first electrode of the 21st transistor;

A gate of the twenty-first transistor is electrically connected to the control clock signal terminal, and a second electrode of the twenty-first transistor is electrically connected to the fourth node;

A gate of the 22nd transistor is electrically connected to the inverted clock signal terminal, a first electrode of the 22nd transistor is electrically connected to the fourth node, and a second electrode of the 22nd transistor is electrically connected to a first electrode of the 23rd transistor;

A gate of the twenty-third transistor is electrically connected to the N-th stage driving signal output terminal, and a second electrode of the twenty-third transistor is electrically connected to the third voltage terminal;

The twentieth transistor and the 21st transistor are p-type transistors, and the 22nd transistor and the 23rd transistor are n-type transistors.

Optionally, the second inverting circuit includes a twenty-fourth transistor and a twenty-fifth transistor; the second initialization circuit includes a twenty-sixth transistor;

The gate of the twenty-fourth transistor is electrically connected to the fourth node, the first electrode of the twenty-fourth transistor is electrically connected to the first voltage terminal, and the second electrode of the twenty-fourth transistor is electrically connected to the first electrode of the 25th transistor and the N-th stage driving signal output terminal;

A gate of the twenty-fifth transistor is electrically connected to the fourth node, and a second electrode of the twenty-fifth transistor is electrically connected to the third voltage terminal;

The twenty-fourth transistor is a p-type transistor, and the twenty-fifth transistor is an n-type transistor;

A gate of the twenty-sixth transistor is electrically connected to the initial control terminal, a first electrode of the twenty-sixth transistor is electrically connected to the first voltage terminal, and a second electrode of the twenty-sixth transistor is electrically connected to the N-th stage driving signal output terminal.

Optionally, the first inverting circuit includes a twenty-seventh transistor and a twenty-eighth transistor;

The gate of the twenty-seventh transistor is electrically connected to the control clock signal terminal, the first electrode of the twenty-seventh transistor is electrically connected to the first voltage terminal, and the second electrode of the twenty-seventh transistor is electrically connected to the first electrode of the twenty-eighth transistor and the inverted clock signal terminal;

A gate of the twenty-eighth transistor is electrically connected to the control clock signal terminal, and a second electrode of the twenty-eighth transistor is electrically connected to the third voltage terminal.

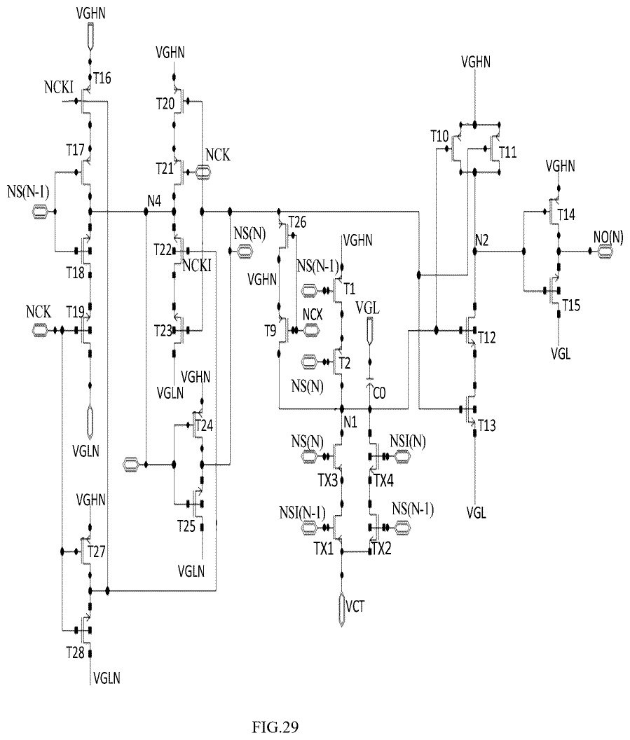

As shown in FIG. 29, based on at least one embodiment of the driving circuit shown in FIG. 28,

The gating control terminal includes a first control terminal, a second control terminal, a third control terminal and a fourth control terminal, and the gating circuit includes a first gating transistor TX1, a second gating transistor TX2, a third gating transistor TX3 and a fourth gating transistor TX4;

The gate of the first gating transistor TX1 is electrically connected to the first control terminal, and the drain of the first gating transistor TX1 is electrically connected to the selection input terminal VCT;

The gate of the second gating transistor TX2 is electrically connected to the second control terminal, and the drain of the second gating transistor TX2 is electrically connected to the selection input terminal VCT;

The gate of the third gating transistor TX3 is electrically connected to the third control terminal, the drain of the third gating transistor TX3 is electrically connected to the source of the first gating transistor TX1, and the source of the third gating transistor TX3 is electrically connected to the first node N1;

The gate of the fourth gating transistor TX4 is electrically connected to the fourth control terminal, the drain of the fourth gating transistor TX4 is electrically connected to the source of the second gating transistor TX2, and the source of the fourth gating transistor TX4 is electrically connected to the first node N1;

The first gating transistor TX1 is a p-type transistor, the second gating transistor TX2 is an n-type transistor, the third gating transistor TX3 is a p-type transistor, and the fourth gating transistor TX4 is an n-type transistor;

The first control terminal is connected to the inverted signal NSI(N−1) of the (N−1)-th level driving signal, the second control terminal is the (N−1)-th level driving signal output terminal NS(N−1), the third control terminal is the N-th level driving signal output terminal NS(N), and the fourth control terminal is connected to the inverted signal NSI(N) of the N-th level driving signal;

The reset circuit includes a first transistor T1 and a second transistor T2;

The gate of the first transistor T1 is electrically connected to the (N−1)-th stage driving signal output terminal NS(N−1), the drain of the first transistor T1 is electrically connected to the high voltage terminal VGHN, and the source of the first transistor T1 is electrically connected to the drain of the second transistor T2;

The gate of the second transistor T2 is electrically connected to the N-th stage driving signal output terminal NS(N), and the source of the second transistor T2 is electrically connected to the first node N1;

T1 and T2 are p-type transistors;

The first initialization circuit includes a ninth transistor T9;

The gate of the ninth transistor T9 is electrically connected to the initial control terminal NCX, the drain of the ninth transistor T9 is electrically connected to the high voltage terminal VGHN, and the source of the ninth transistor T9 is electrically connected to the first node N1;

T9 is a p-type transistor;

The first voltage maintaining circuit includes a capacitor C0;

The first terminal of the capacitor C0 is electrically connected to the first node N1, and the second end of the capacitor C0 is electrically connected to the first low voltage end VGL;

The output control circuit includes a tenth transistor T10, an eleventh transistor T11, a twelfth transistor T12 and a thirteenth transistor T13;

The gate of the tenth transistor T10 is electrically connected to the first node N1, the drain of the tenth transistor T10 is electrically connected to the high voltage terminal VGHN, and the source of the tenth transistor T10 is electrically connected to the second node N2;

The gate of the eleventh transistor T11 is electrically connected to the N-th stage driving signal output terminal NS(N), the drain of the eleventh transistor T11 is electrically connected to the high voltage terminal VGHN, and the source of the eleventh transistor T11 is electrically connected to the second node N2;
the twelfth transistor T12 is electrically connected to the first node N1, the drain of the twelfth transistor T12 is electrically connected to the second node N2, and the source of the twelfth transistor T12 is electrically connected to the drain of the thirteenth transistor T13;

The gate of the thirteenth transistor T13 is electrically connected to the N-level driving signal output terminal NS(N), and the source of the thirteenth transistor T13 is electrically connected to the first low voltage terminal VGL;

The tenth transistor T10 and the eleventh transistor T11 are p-type transistors, and the twelfth transistor T12 and the thirteenth transistor T13 are n-type transistors;

The output circuit includes a fourteenth transistor T14 and a fifteenth transistor T15;

The gate of the fourteenth transistor T14 is electrically connected to the second node N2, the drain of the fourteenth transistor T14 is electrically connected to the high voltage terminal VGHN, and the source of the fourteenth transistor T14 is electrically connected to the output driving terminal NO (N);

The gate of the fifteenth transistor T15 is electrically connected to the second node N2, the drain of the fifteenth transistor T15 is electrically connected to the output driving terminal NO (N), and the source of the fifteenth transistor T15 is electrically connected to the first low voltage terminal VGL;

T14 is a p-type transistor, and T15 is a p-type transistor;

The first driving control circuit includes a sixteenth transistor T16, a seventeenth transistor T17, an eighteenth transistor T18 and a nineteenth transistor T19;

The gate of the sixteenth transistor T16 is electrically connected to the inverted clock signal terminal NCKI, the drain of the sixteenth transistor T16 is electrically connected to the high voltage terminal VGHN, and the source of the sixteenth transistor T16 is electrically connected to the drain of the seventeenth transistor T17;

The gate of the seventeenth transistor T17 is electrically connected to the (N−1)-th stage driving signal output terminal NS(N−1), and the source of the seventeenth transistor T17 is electrically connected to the fourth node N4;

The gate of the eighteenth transistor T18 is electrically connected to the (N−1)-th stage driving signal output terminal NS(N−1), the drain of the eighteenth transistor T18 is electrically connected to the fourth node N4, and the source of the eighteenth transistor T18 is electrically connected to the drain of the nineteenth transistor T19;

The gate of the nineteenth transistor T19 is electrically connected to the control clock signal terminal NCK, and the source of the nineteenth transistor T19 is electrically connected to the second low voltage terminal VGLN;

The sixteenth transistor T16 and the seventeenth transistor T17 are p-type transistors, and the eighteenth transistor T18 and the nineteenth transistor T19 are n-type transistors;

The second driving control circuit includes a twentieth transistor T20, a twenty-first transistor T21, a twenty-second transistor T22 and a twenty-third transistor T23;

The gate of the twentieth transistor T20 is electrically connected to the N-th stage driving signal output terminal NS(N), the drain of the twentieth transistor T20 is electrically connected to the high voltage terminal VGHN, and the source of the twentieth transistor T20 is electrically connected to the drain of the 21st transistor T21;

A gate of the twenty-first transistor T21 is electrically connected to the control clock signal terminal NCK, and a source of the twenty-first transistor T21 is electrically connected to the fourth node N4;
the 22nd transistor T22 is electrically connected to the inverted clock signal terminal NCKI, a drain of the 22nd transistor T22 is electrically connected to the fourth node N4, and a source of the 22nd transistor T22 is electrically connected to a drain of the 23rd transistor T23;

A gate of the twenty-third transistor T23 is electrically connected to the N-th stage driving signal output terminal NS(N), and a source of the twenty-third transistor T23 is electrically connected to the second low voltage terminal VGLN;

The twentieth transistor T20 and the 21st transistor T21 are p-type transistors, and the 22nd transistor T22 and the 23rd transistor T23 are n-type transistors;

The second inverting circuit includes a twenty-fourth transistor T24 and a twenty-fifth transistor T25; the second initialization circuit includes a twenty-sixth transistor T26;

The gate of the twenty-fourth transistor T24 is electrically connected to the fourth node N4, the drain of the twenty-fourth transistor T24 is electrically connected to the high voltage terminal VGHN, and the source of the twenty-fourth transistor T24 is electrically connected to the drain of the 25th transistor T25 and the N-th stage driving signal output terminal NS(N);

A gate of the twenty-fifth transistor T25 is electrically connected to the fourth node N4, and a source of the twenty-fifth transistor T25 is electrically connected to the second low voltage terminal VGLN;

The twenty-fourth transistor T24 is a p-type transistor, and the twenty-fifth transistor T25 is an n-type transistor;

The gate of the 26th transistor T26 is electrically connected to the initial control terminal NCX, the drain of the 26th transistor T26 is electrically connected to the high voltage terminal VGHN, and the source of the 26th transistor T26 is electrically connected to the N-th stage driving signal output terminal NS(N);

The twenty-sixth transistor T26 is a p-type transistor;

The first inverting circuit includes a twenty-seventh transistor T27 and a twenty-eighth transistor T28;

The gate of the twenty-seventh transistor T27 is electrically connected to the control clock signal terminal NCK, the drain of the twenty-seventh transistor T27 is electrically connected to the high voltage terminal VGHN, and the source of the twenty-seventh transistor T27 is electrically connected to the drain of the twenty-eighth transistor T28 and the inverted clock signal terminal NCKI;

A gate of the 28th transistor T28 is electrically connected to the control clock signal terminal NCK, and a source of the 28th transistor T28 is electrically connected to the second low voltage terminal VGLN;

The twenty-seventh transistor T27 is a p-type transistor, and the twenty-eighth transistor T28 is an n-type transistor.

In at least one embodiment of the driving circuit shown in FIG. 29, the voltage value of the second low voltage signal provided by VGLN can be smaller than the voltage value of the first low voltage signal provided by VGL, so that when the N-level driving signal output terminal NS (N) outputs a low voltage signal and the potential of the first node N1 is a low voltage, T12 and T13 can be well turned off.

In at least one embodiment of the driving circuit shown in FIG. 29, the first voltage terminal is a high voltage terminal VGHN, the second voltage terminal is a first low voltage terminal VGL, and the third voltage terminal is a second low voltage terminal VGLN.

At least one embodiment of the driving circuit described in FIG. 29 of the present disclosure is in operation.

1. When GCK provides a high voltage signal, T19 is turned on and T20 is turned off. GCB provides a low voltage signal, T16 is turned on and T23 is turned off. At this time, the driving signal generation circuit is in the transmission state.

When NS (N) provides a low voltage signal, T17 is turned on, T18 is turned off, the potential of N6 is high voltage, T25 is turned on, T24 is turned off, NS (N) provides a low voltage signal, and NS (N−1) provides a low voltage signal;

When NS (N) provides a high voltage signal, T17 is closed, T18 is opened, the potential of N6 is low voltage, T25 is closed, T24 is opened, and NS (N) and NS (N−1) both provide high voltage signals;

2. When GCK provides a low voltage signal, T19 is turned off and T20 is turned on. GCB provides a high voltage signal, T16 is turned off and T23 is turned on. At this time, the circuit is in the register state. T21, T22, T23 and T11 form a latch circuit. The potential of N6 and the signal provided by NS (N) maintain the previous state unchanged.

3. When the signal provided by NS (N−1) switches from a low voltage signal to a high voltage signal, GCK provides a low voltage signal, closes T19, opens T20, GCB provides a high voltage signal, closes T16, and opens T23. At this time, the circuit is in the register state. T21, T22, T23, and T11 form a latch circuit. The potential of N6 and the signal provided by NS (N) maintain the previous low voltage state unchanged, completing the shift. At the next moment, GCK provides a high voltage signal, opens T19, closes T20, GCB provides a low voltage signal, opens T16, and closes T23. At this time, the circuit is in the transmission state. NS (N−1) provides a high voltage signal, closes T17, opens T18, the potential of N6 is low voltage, closes T25, and opens T24. NS (N) and NS (N−1) both provide high voltage signals to realize the shift register from NS (N−1) to NS (N);

4. When NS (N−1) switches from providing a high voltage signal to providing a low voltage signal, GCK provides a low voltage signal, turns off T19, turns on T20, GCB provides a high voltage signal, turns off T16, and turns on T23. At this time, the circuit is in the register state. T21, T22, T23 and T11 form a latch circuit. The potential of N6 and the signal provided by NS (N) remain unchanged at the previous high voltage state, and the shift is completed; at the next moment, GCK provides a high voltage signal, turns on T19, turns off T20, GCB provides a low voltage signal, turns on T16, and turns off T23. At this time, the circuit is in the transmission state, NS (N−1) provides a low voltage signal, turns on T17, turns off T18, the potential of N6 is high voltage, turns on T25, and turns off T24. NS (N) and NS (N−1) both provide low voltage signals to realize the shift register from NS (N−1) to NS (N).

At least one embodiment of the driving circuit shown in FIG. 29 of the present disclosure is in operation.

When NS (N−1) provides a high voltage signal, TX1 and TX2 are turned on, and when NS (N) provides a low voltage signal, TX3 and TX4 are turned on. By simultaneously selecting the two signals, the state of the selection input signal provided by VCT within a high-low frequency switching cycle H can be obtained and written into the first node N1. Then TX1, TX2, TX3 and TX4 will not be turned on at the same time at other times to prevent the potential of N1 from being affected by the potential change of the selection input signal provided by VCT. T10, T11, T12 and T13 form a NAND gate, the input signals of which are the signal provided by NS (N) and the potential of N1, respectively, and the output end of the NAND gate is electrically connected to the second node N2. T24 and T25 form a second inverting circuit, the input end of the second inverting circuit is electrically connected to the fourth node N4, and the output end of the second inverting circuit is electrically connected to NS (N);

If VCT provides a high voltage signal when TX1, TX2, TX3, and TX4 are turned on, N1 will be written with a high voltage, and the gate state of the NAND gate can ensure that NS (N) is normally passed to NO (N);

If VCT provides a low voltage signal when TX1, TX2, TX3 and TX4 are turned on, N1 will be written with a low voltage, and the NAND gate is in the cut-off state, ensuring that NO (N) provides a low voltage signal, thereby achieving the low level maintenance of NO (N).

Optionally, when the display starts (that is, when the display device is turned on), in the power-on stage before the first stage, NCX outputs a low voltage signal, T9 is turned on to control the potential of N1 to be a high voltage, and T26 is turned on so that NS (N) provides a high voltage signal; at this time, T12 and T13 are both turned on, the potential of N2 is a low voltage, T14 is turned on, T15 is turned off, and NO (N) outputs a high voltage signal, so that the second display control transistor M2 included in all pixel circuits in the effective display area can be turned on, and the residual charge in the storage capacitor Cst is cleared, thereby improving the screen flickering problem when the screen is turned on;

Afterwards, when NS (N−1) outputs a high voltage signal and NS (N) outputs a low voltage signal, TX1, TX2, TX3, and TX4 are turned on.

When VCT provides a low voltage signal, the potential of N1 is a low voltage signal, and C0 maintains the potential of N1; T11 is turned on, T10 is turned on, the potential of N2 is a high voltage, T15 is turned on, and NO (N) outputs a low voltage signal;

When VCT provides a high voltage signal, the potential of N1 is a high voltage signal, C0 maintains the potential of N1, T11 is turned off, T10 is turned on, the potential of N2 is a high voltage, T15 is turned on, and NO (N) outputs a low voltage signal;

Afterwards, in the N-th stage of driving signal provision, NS (N) outputs a high voltage signal.

When the potential of N1 is low voltage, T10 is turned off, T11 is turned on, the potential of N2 is high voltage, T15 is turned on, and NO (N) outputs a low voltage signal;

When the potential of N1 is high voltage, T10 is turned off, T11 is turned off, T12 and T13 are turned on, the potential of N2 is low voltage, T14 is turned on, and NO (N) outputs a high voltage signal;

After the N-th stage of driving signal supply, NS (N) outputs a low voltage signal.

When the potential of N1 is a low voltage signal, T10 is turned on, T11 is turned on, the potential of N2 is a high voltage, and NO (N) outputs a low voltage signal;

When the potential of N1 is a high voltage signal, T10 is turned on, T11 is turned off, the potential of N2 is a high voltage, and NO (N) outputs a low voltage signal.

When at least one embodiment of the driving circuit shown in FIG. 29 of the present disclosure is in operation, when NS (N−1) outputs a high voltage signal and NS (N) outputs a low voltage signal, TX1, TX2, TX3 and TX4 are turned on, and by simultaneously selecting the above two signals, the selection input signal state within a high-low frequency switching cycle can be obtained.

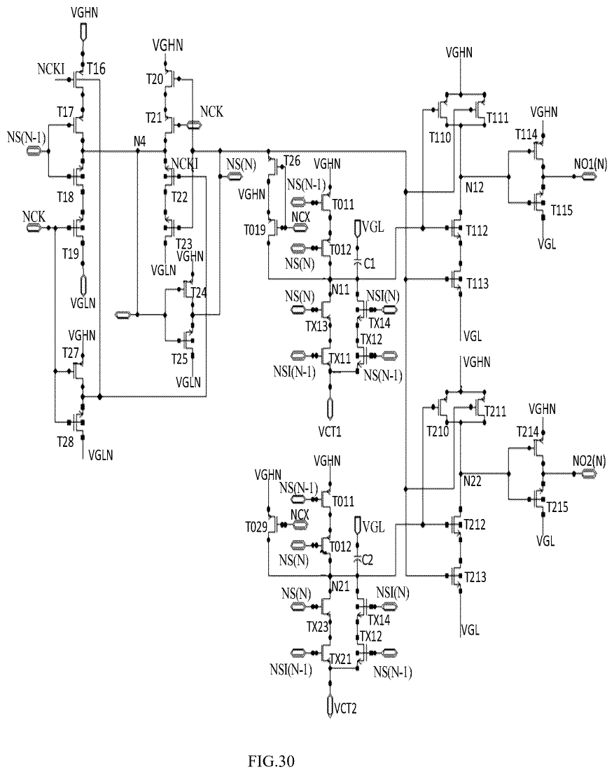

As shown in FIG. 30, based on at least one embodiment of the driving circuit shown in FIG. 27,

The first gating circuit includes a first first gating transistor TX11, a first second gating transistor TX12, a first third gating transistor TX13 and a first fourth gating transistor TX14;

The second gating circuit includes a second first gating transistor TX21, a second second gating transistor TX22, a second third gating transistor TX23 and a second fourth gating transistor TX24;

The gate of the first first gating transistor TX11 is connected to the inverted signal NSI(N−1) of the (N−1)-th stage driving signal, and the drain of the first first gating transistor TX11 is electrically connected to the first selection input terminal VCT1;

The gate of the first second gating transistor TX12 is electrically connected to the (N−1)-th stage driving signal output terminal NS(N−1), and the drain of the first second gating transistor TX12 is electrically connected to the first selection input terminal VCT1;

The gate of the first third gating transistor TX13 is electrically connected to the N-th stage driving signal output terminal NS(N), the drain of the first third gating transistor TX13 is electrically connected to the source of the first first gating transistor TX11, and the source of the first third gating transistor TX13 is electrically connected to the first first node N11;

The gate of the first fourth gating transistor TX14 is connected to the inverted signal NSI (N) of the N-th stage driving signal, the drain of the first fourth gating transistor TX14 is electrically connected to the source of the first second gating transistor TX12, and the source of the first fourth gating transistor TX14 is electrically connected to the first first node N11;

The first first gating transistor TX11 is a p-type transistor, the first second gating transistor TX12 is an n-type transistor, the first third gating transistor TX13 is a p-type transistor, and the first fourth gating transistor TX14 is an n-type transistor;

The gate of the second first gating transistor TX21 is connected to the inverted signal NSI(N−1) of the (N−1)-th stage driving signal, and the drain of the second first gating transistor TX21 is electrically connected to the second selection input terminal VCT2;

The gate of the second second gating transistor TX22 is electrically connected to the (N−1)-th stage driving signal output terminal NS(N−1), and the drain of the second second gating transistor TX22 is electrically connected to the second selection input terminal VCT2;

The gate of the second third gating transistor TX23 is electrically connected to the N-th stage driving signal output terminal NS(N), the drain of the second third gating transistor TX23 is electrically connected to the source of the second first gating transistor TX21, and the source of the second third gating transistor TX23 is electrically connected to the second first node N21;

The gate of the second fourth gating transistor TX24 is connected to the inverted signal NSI (N) of the N-th stage driving signal, the drain of the second fourth gating transistor TX24 is electrically connected to the source of the second second gating transistor TX22, and the source of the second fourth gating transistor TX24 is electrically connected to the second first node N21;

The second first gating transistor TX21 is a p-type transistor, the second second gating transistor TX22 is an n-type transistor, the second third gating transistor TX23 is a p-type transistor, and the second fourth gating transistor TX24 is an n-type transistor;

The first reset circuit includes a first first transistor T011 and a first second transistor T012;

The gate of the first first transistor T011 is electrically connected to the (N−1)-th stage driving signal output terminal NS(N−1), the drain of the first first transistor T011 is electrically connected to the high voltage terminal VGHN, and the source of the first first transistor T011 is electrically connected to the drain of the first second transistor T012;

The gate of the first second transistor T012 is electrically connected to the N-th stage driving signal output terminal NS(N), and the source of the first second transistor T012 is electrically connected to the first first node N11;

T011 and T012 are p-type transistors;

The second reset circuit includes a second first transistor T021 and a second second transistor T022;

The gate of the second first transistor T021 is electrically connected to the (N−1)-th stage driving signal output terminal NS(N−1), the drain of the second first transistor T021 is electrically connected to the high voltage terminal VGHN, and the source of the second first transistor T021 is electrically connected to the drain of the second second transistor T022;

The gate of the second second transistor T022 is electrically connected to the N-th stage driving signal output terminal NS(N), and the source of the second second transistor T022 is electrically connected to the second first node N21;

T021 and T022 are p-type transistors;

The first first initialization circuit includes a first ninth transistor T019;

The gate of the first ninth transistor T019 is electrically connected to the initial control terminal NCX, the drain of the first ninth transistor T019 is electrically connected to the high voltage terminal VGHN, and the source of the first ninth transistor T019 is electrically connected to the first first node N11;

T019 is a p-type transistor;

The first first voltage maintaining circuit includes a first capacitor C1; the second first voltage maintaining circuit includes a second capacitor C2;

The first terminal of the first capacitor C1 is electrically connected to the first first node N11, and the second end of the first capacitor C1 is electrically connected to the first low voltage end VGL;

The first terminal of the second capacitor C2 is electrically connected to the second first node N21, and the second end of the second capacitor C2 is electrically connected to the first low voltage end VGL;

The first output control circuit includes a first tenth transistor T110, a first eleventh transistor T111, a first twelfth transistor T112 and a first thirteenth transistor T113;

The gate of the first tenth transistor T110 is electrically connected to the first first node N11, the drain of the first tenth transistor T110 is electrically connected to the high voltage terminal VGHN, and the source of the first tenth transistor T110 is electrically connected to the first second node N12;

The gate of the first eleventh transistor T111 is electrically connected to the N-th stage driving signal output terminal NS(N), the drain of the first eleventh transistor T111 is electrically connected to the high voltage terminal VGHN, and the source of the first eleventh transistor T111 is electrically connected to the first second node N12;

The gate of the first twelfth transistor T112 is electrically connected to the first first node N11, the drain of the first twelfth transistor T112 is electrically connected to the first second node N12, and the source of the first twelfth transistor T112 is electrically connected to the drain of the first thirteenth transistor T113;

The gate of the first thirteenth transistor T113 is electrically connected to the N-level driving signal output terminal NS(N), and the source of the first thirteenth transistor T113 is electrically connected to the first low voltage terminal VGL;

The first tenth transistor T110 and the first eleventh transistor T111 are p-type transistors, and the first twelfth transistor T112 and the first thirteenth transistor T113 are n-type transistors;

The first output circuit includes a first fourteenth transistor T114 and a first fifteenth transistor T115;

The gate of the first fourteenth transistor T114 is electrically connected to the first second node N12, the drain of the first fourteenth transistor T114 is electrically connected to the high voltage terminal VGHN, and the source of the first fourteenth transistor T114 is electrically connected to the first output driving terminal NO1 (N);

The gate of the first fifteenth transistor T115 is electrically connected to the first second node N12, the drain of the first fifteenth transistor T115 is electrically connected to the first output driving terminal NO1 (N), and the source of the first fifteenth transistor T115 is electrically connected to the first low voltage terminal VGL;

T114 is a p-type transistor, and T115 is a p-type transistor;

The first first initialization circuit includes a first ninth transistor T019;

The gate of the first ninth transistor T019 is electrically connected to the initial control terminal NCX, the drain of the first ninth transistor T019 is electrically connected to the high voltage terminal VGHN, and the source of the first ninth transistor T019 is electrically connected to the first first node N11;

T019 is a p-type transistor;

The second first initialization circuit includes a second ninth transistor T029;

The gate of the second ninth transistor T029 is electrically connected to the initial control terminal NCX, the drain of the second ninth transistor T029 is electrically connected to the high voltage terminal VGHN, and the source of the second ninth transistor T029 is electrically connected to the second first node N21;

T029 is a p-type transistor;

The first first voltage maintaining circuit includes a first capacitor C1; the second first voltage maintaining circuit includes a second capacitor C2;

The first terminal of the first capacitor C1 is electrically connected to the first first node N11, and the second end of the first capacitor C1 is electrically connected to the first low voltage end VGL;

The first terminal of the second capacitor C2 is electrically connected to the second first node N21, and the second end of the second capacitor C2 is electrically connected to the first low voltage end VGL;

The first output control circuit includes a first tenth transistor T110, a first eleventh transistor T111, a first twelfth transistor T112 and a first thirteenth transistor T113;

The gate of the first tenth transistor T110 is electrically connected to the first first node N11, the drain of the first tenth transistor T110 is electrically connected to the high voltage terminal VGHN, and the source of the first tenth transistor T110 is electrically connected to the first second node N12;

The gate of the first eleventh transistor T111 is electrically connected to the N-th stage driving signal output terminal NS(N), the drain of the first eleventh transistor T111 is electrically connected to the high voltage terminal VGHN, and the source of the first eleventh transistor T111 is electrically connected to the first second node N12;

The gate of the first twelfth transistor T112 is electrically connected to the first first node N11, the drain of the first twelfth transistor T112 is electrically connected to the first second node N12, and the source of the first twelfth transistor T112 is electrically connected to the drain of the first thirteenth transistor T113;

The gate of the first thirteenth transistor T113 is electrically connected to the N-level driving signal output terminal NS(N), and the source of the first thirteenth transistor T113 is electrically connected to the first low voltage terminal VGL;

The first tenth transistor T110 and the first eleventh transistor T111 are p-type transistors, and the first twelfth transistor T112 and the first thirteenth transistor T113 are n-type transistors;

The first output circuit includes a first fourteenth transistor T114 and a first fifteenth transistor T115;

The gate of the first fourteenth transistor T114 is electrically connected to the first second node N12, the drain of the first fourteenth transistor T114 is electrically connected to the high voltage terminal VGHN, and the source of the first fourteenth transistor T114 is electrically connected to the first output driving terminal NO1 (N);

The gate of the first fifteenth transistor T115 is electrically connected to the first second node N12, the drain of the first fifteenth transistor T115 is electrically connected to the first output driving terminal NO1 (N), and the source of the first fifteenth transistor T115 is electrically connected to the first low voltage terminal VGL;

T114 is a p-type transistor, and T115 is a p-type transistor;

The second output control circuit includes a second tenth transistor T210, a second eleventh transistor T211, a second twelfth transistor T112 and a second thirteenth transistor T213;

The gate of the second tenth transistor T210 is electrically connected to the second first node N21, the drain of the second tenth transistor T210 is electrically connected to the high voltage terminal VGHN, and the source of the second tenth transistor T110 is electrically connected to the second second node N22;

The gate of the second eleventh transistor T211 is electrically connected to the N-th stage driving signal output terminal NS(N), the drain of the second eleventh transistor T211 is electrically connected to the high voltage terminal VGHN, and the source of the second eleventh transistor T211 is electrically connected to the second second node N22;

The gate of the second twelfth transistor T212 is electrically connected to the second first node N21, the drain of the second twelfth transistor T212 is electrically connected to the second second node N22, and the source of the second twelfth transistor T212 is electrically connected to the drain of the second thirteenth transistor T213;

The gate of the second thirteenth transistor T213 is electrically connected to the N-level driving signal output terminal NS(N), and the source of the second thirteenth transistor T213 is electrically connected to the first low voltage terminal VGL;

The second tenth transistor T210 and the second eleventh transistor T211 are p-type transistors, and the second twelfth transistor T212 and the second thirteenth transistor T213 are n-type transistors;

The second output circuit includes a second fourteenth transistor T214 and a second fifteenth transistor T215;

The gate of the second fourteenth transistor T214 is electrically connected to the second second node N22, the drain of the second fourteenth transistor T214 is electrically connected to the high voltage terminal VGHN, and the source of the second fourteenth transistor T214 is electrically connected to the second output driving terminal NO2 (N);

The gate of the second fifteenth transistor T215 is electrically connected to the second second node N22, the drain of the second fifteenth transistor T215 is electrically connected to the second output driving terminal NO2 (N), and the source of the second fifteenth transistor T215 is electrically connected to the first low voltage terminal VGL;

T114 is a p-type transistor, and T115 is a p-type transistor;

The first driving control circuit includes a sixteenth transistor T16, a seventeenth transistor T17, an eighteenth transistor T18 and a nineteenth transistor T19;

The gate of the sixteenth transistor T16 is electrically connected to the inverted clock signal terminal NCKI, the drain of the sixteenth transistor T16 is electrically connected to the high voltage terminal VGHN, and the source of the sixteenth transistor T16 is electrically connected to the drain of the seventeenth transistor T17;

The gate of the seventeenth transistor T17 is electrically connected to the (N−1)-th stage driving signal output terminal NS(N−1), and the source of the seventeenth transistor T17 is electrically connected to the fourth node N4;

The gate of the eighteenth transistor T18 is electrically connected to the (N−1)-th stage driving signal output terminal NS(N−1), the drain of the eighteenth transistor T18 is electrically connected to the fourth node N4, and the source of the eighteenth transistor T18 is electrically connected to the drain of the nineteenth transistor T19;

The gate of the nineteenth transistor T19 is electrically connected to the control clock signal terminal NCK, and the source of the nineteenth transistor T19 is electrically connected to the second low voltage terminal LVGL;

The sixteenth transistor T16 and the seventeenth transistor T17 are p-type transistors, and the eighteenth transistor T18 and the nineteenth transistor T19 are n-type transistors;

The second driving control circuit includes a twentieth transistor T20, a twenty-first transistor T21, a twenty-second transistor T22 and a twenty-third transistor T23;

A gate of the twentieth transistor T20 is electrically connected to the control clock signal terminal NCK, a drain of the twentieth transistor T20 is electrically connected to the high voltage terminal VGHN, and a source of the twentieth transistor T20 is electrically connected to a drain of the 21st transistor T21;

A gate of the twenty-first transistor T21 is electrically connected to the N-th stage driving signal output terminal NS(N), and a source of the twenty-first transistor T21 is electrically connected to the fourth node N4;

The gate of the 22nd transistor T22 is electrically connected to the N-th stage driving signal output terminal NS(N), the drain of the 22nd transistor T22 is electrically connected to the fourth node N4, and the source of the 22nd transistor T22 is electrically connected to the drain of the 23rd transistor T23;

A gate of the twenty-third transistor T23 is electrically connected to the inverted clock signal terminal NCKI, and a source of the twenty-third transistor T23 is electrically connected to the second low voltage terminal VGLN;

The twentieth transistor T20 and the 21st transistor T21 are p-type transistors, and the 22nd transistor T22 and the 23rd transistor T23 are n-type transistors;

The second inverting circuit includes a twenty-fourth transistor T24 and a twenty-fifth transistor T25; the second initialization circuit includes a twenty-sixth transistor T26;

The gate of the twenty-fourth transistor T24 is electrically connected to the fourth node N4, the drain of the twenty-fourth transistor T24 is electrically connected to the high voltage terminal VGHN, and the source of the twenty-fourth transistor T24 is electrically connected to the drain of the 25th transistor T25 and the N-th stage driving signal output terminal NS(N);

A gate of the twenty-fifth transistor T25 is electrically connected to the fourth node N4, and a source of the twenty-fifth transistor T25 is electrically connected to the second low voltage terminal VGLN;

The twenty-fourth transistor T24 is a p-type transistor, and the twenty-fifth transistor T25 is an n-type transistor;

The gate of the 26th transistor T26 is electrically connected to the initial control terminal NCX, the drain of the 26th transistor T26 is electrically connected to the high voltage terminal VGHN, and the source of the 26th transistor T26 is electrically connected to the N-th stage driving signal output terminal NS(N);

The twenty-sixth transistor T26 is a p-type transistor;

The first inverting circuit includes a twenty-seventh transistor T27 and a twenty-eighth transistor T28;

The gate of the twenty-seventh transistor T27 is electrically connected to the control clock signal terminal NCK, the drain of the twenty-seventh transistor T27 is electrically connected to the high voltage terminal VGHN, and the source of the twenty-seventh transistor T27 is electrically connected to the drain of the twenty-eighth transistor T28 and the inverted clock signal terminal NCKI;

A gate of the 28th transistor T28 is electrically connected to the control clock signal terminal NCK, and a source of the 28th transistor T28 is electrically connected to the second low voltage terminal VGLN;

The twenty-seventh transistor T27 is a p-type transistor, and the twenty-eighth transistor T28 is an n-type transistor.

FIG. 30, the voltage value of the second low voltage signal provided by VGLN can be smaller than the voltage value of the first low voltage signal provided by VGL, so that when the N-level driving signal output terminal NS (N) outputs a low voltage signal and the potential of the first node N1 is a low voltage, T12 and T13 can be well turned off.

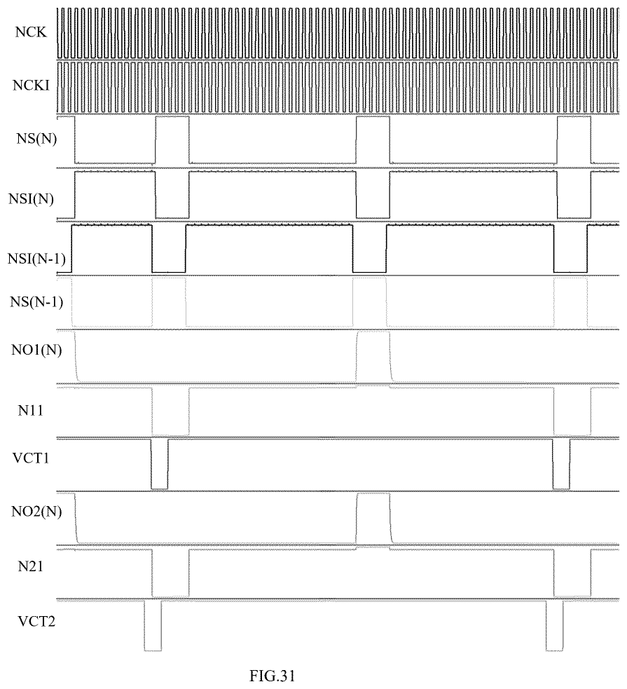

FIG. 31 is an operation timing diagram of at least one embodiment of the driving circuit shown in FIG. 30.

In at least one embodiment of the driving circuit shown in FIG. 30, control signals can be written independently to VCT1 and VCT2 to achieve separate output control of NO1 (N) and NO2 (N).

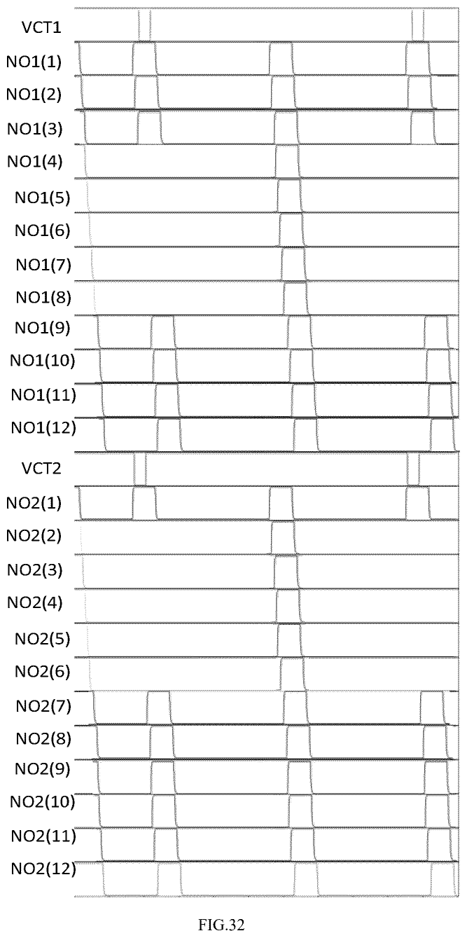

In FIG. 32, the first output driver terminal of the first level is labeled NO1(1), the first output driver terminal of the second level is labeled NO1(2), the first output driver terminal of the third level is labeled NO1(3), the first output driver terminal of the fourth level is labeled NO1(4), the first output driver terminal of the fifth level is labeled NO1(5), the first output driver terminal of the sixth level is labeled NO1(6), the first output driver terminal of the seventh level is labeled NO1(7), the first output driver terminal of the eighth level is labeled NO1(8), the first output driver terminal of the ninth level is labeled NO1(9), the first output driver terminal of the tenth level is labeled NO1(10), the first output driver terminal of the eleventh level is labeled NO1(11), and the first output driver terminal of the twelfth level is labeled NO1(12);

The first-level second output driver terminal is labeled NO2(1), the second-level second output driver terminal is labeled NO2(2), the third-level second output driver terminal is labeled NO2(3), the fourth-level second output driver terminal is labeled NO2(4), the fifth-level second output driver terminal is labeled NO2(5), the sixth-level second output driver terminal is labeled NO2(6), the seventh-level second output driver terminal is labeled NO2(7), the eighth-level second output driver terminal is labeled NO2(8), the ninth-level second output driver terminal is labeled NO2(9), the tenth-level second output driver terminal is labeled NO2(10), the eleventh-level second output driver terminal is labeled NO2(11), and the twelfth-level second output driver terminal is labeled NO2(12).

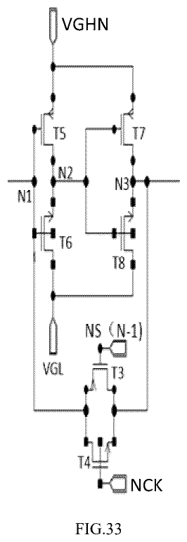

As shown in FIG. 33, at least one embodiment of the second voltage maintaining circuit may include a maintaining control circuit, a first inverter, and a second inverter;

The maintaining control circuit may include a third transistor T3 and a fourth transistor T4;

The gate of the third transistor T3 is electrically connected to the (N−1)-th stage driving signal terminal NS(N−1), the drain of the third transistor T3 is electrically connected to the first node N1, and the source of the third transistor T3 is electrically connected to the third node N3;

The gate of the fourth transistor T4 is electrically connected to the control clock signal terminal, the drain of the fourth transistor T4 is electrically connected to the third node N3, and the source of the fourth transistor T4 is electrically connected to the first node N1;

The third transistor T3 is a p-type transistor, and the fourth transistor T4 is an n-type transistor;

The first inverter includes a fifth transistor T5 and a sixth transistor T6, and the second inverter includes a seventh transistor T7 and an eighth transistor T8;

The gate of the fifth transistor T5 is electrically connected to the first node N1, the drain of the fifth transistor T5 is electrically connected to the high voltage terminal VGHN, and the source of the fifth transistor T5 is electrically connected to the second node N2;

The gate of the sixth transistor T6 is electrically connected to the first node N1, the drain of the sixth transistor T6 is electrically connected to the second node N2, and the source of the sixth transistor T6 is electrically connected to the first low voltage terminal VGL;

The fifth transistor T5 is a p-type transistor, and the sixth transistor T6 is an n-type transistor;

The gate of the seventh transistor T7 is electrically connected to the second node N2, the drain of the seventh transistor T7 is electrically connected to the high voltage terminal VGHN, and the source of the seventh transistor T7 is electrically connected to the third node N3;

The gate of the eighth transistor T8 is electrically connected to the second node N2, the drain of the eighth transistor T8 is electrically connected to the third node N3, and the source of the eighth transistor T8 is electrically connected to the first low voltage terminal VGL;

The seventh transistor T7 is a p-type transistor, and the eighth transistor T8 is an n-type transistor.

In at least one embodiment of the second voltage maintaining circuit shown in FIG. 33, the gate of the third transistor T3 may be replaced by being electrically connected to the inverted clock signal terminal NCKI or the first clock signal terminal.

In at least one embodiment of the present disclosure, since the p-type transistor has a threshold voltage loss when transmitting a low voltage and the n-type transistor has a threshold voltage loss when transmitting a high voltage, the absolute value of the potential of N1 will be lower, and the absolute value of the potential of N1 can be controlled to increase by the first inverter and the second inverter, so as to better control the corresponding transistors in the output circuit to be turned on or off, and maintain the control circuit to control the disconnection between N1 and N3 when each gating transistor is turned on, so as not to affect the writing of the potential of N1.

The driving method described in at least one embodiment of the present disclosure is applied to the above-mentioned driving circuit, and the driving method includes:

The driving signal generating circuit performs a shift operation on the (N−1)-th level driving signal under the control of the control clock signal, obtains and outputs the N-th level driving signal through the N-th level driving signal output terminal;

The m-th gating circuit controls, under the control of the m-th gating control signal, to write the m-th gating input signal into the m-th first node;

The m-th output control circuit performs a NAND operation on the N-th stage driving signal and the potential of the second end of the m-th output control circuit to obtain an m-th first output signal;

The m-th output circuit is used for inverting the m-th first output signal, and obtaining and providing the m-th output driving signal through the m-th output driving terminal;

M is a positive integer; m is a positive integer less than or equal to M, and N is a positive integer.

The display device described in the embodiment of the present disclosure includes the above-mentioned driving circuit.

The above is a preferred embodiment of the present disclosure. It should be pointed out that for ordinary technicians in this technical field, several improvements and modifications can be made without departing from the principles described in the present disclosure. These improvements and modifications should also be regarded as

1. A driving circuit, comprising a driving signal generating circuit, M output driving terminals and M control circuits; an m-th control circuit comprises an m-th gating circuit, an m-th output control circuit and an m-th output circuit; M is a positive integer; m is a positive integer less than or equal to M;
the driving signal generating circuit is electrically connected to a control clock signal terminal, an (N−1)-th level driving signal output terminal and an N-th level driving signal output terminal, and is configured to perform a shift operation on the (N−1)-th level driving signal provided by the (N−1)-th level driving signal output terminal under a control of a control clock signal provided by the control clock signal terminal, to obtain and output an N-th level driving signal through the N-th level driving signal output terminal;
the m-th gating circuit is electrically connected to an m-th first node, an m-th gating input terminal and an m-th gating control terminal, and is configured to control a writing of the m-th gating input signal provided by the m-th gating input terminal into the m-th first node under the control of the m-th gating control signal provided by the m-th gating control terminal;
a first terminal of the m-th output control circuit is electrically connected to the N-th level driving signal output end, and the second end of the m-th output control circuit is electrically connected to the m-th first node, and is configured to perform a NAND operation on the N-th level driving signal and a potential of a second end of the m-th output control circuit to obtain an m-th first output signal; and
the m-th output circuit is configured to invert the m-th first output signal, and obtain an m-th output driving signal through the m-th output driving terminal;
N is a positive integer.

2. The driving circuit according to claim 1, further comprising a first inverting circuit;
the first inversion circuit is electrically connected to the control clock signal terminal and the inverted clock signal terminal respectively, and is configured to invert the control clock signal to obtain an inverted clock signal, and output the inverted clock signal through the inverted clock signal terminal;
the driving signal generating circuit is further electrically connected to the inverted clock signal terminal, and is further configured to shift the (N−1)-th level driving signal provided by the (N−1)-th level driving signal output terminal under the control of the inverted clock signal, to obtain and output the N-th level driving signal through the N-th level driving signal output terminal.

3. The driving circuit according to claim 1, wherein the m-th gating circuit is configured to control the writing of the m-th selection input signal provided by the m-th selection input terminal into the m-th first node when the potential of the (N−1)-th level driving signal is the first voltage and the potential of the N-th level driving signal is the second voltage.

4. The driving circuit according to claim 1, wherein the m-th gating control terminal comprises an m-th first control terminal, an m-th second control terminal, an m-th third control terminal and an m-th fourth control terminal, and the m-th gating circuit comprises an m-th first gating transistor, an m-th second gating transistor, an m-th third gating transistor and an m-th fourth gating transistor;
a gate of the m-th first gating transistor is electrically connected to the m-th first control terminal, and the first electrode of the m-th first gating transistor is electrically connected to the m-th gating input terminal;
a gate of the m-th second gating transistor is electrically connected to the m-th second control terminal, and the first electrode of the m-th second gating transistor is electrically connected to the m-th selection input terminal;
a gate of the m-th third gating transistor is electrically connected to the m-th third control terminal, the first electrode of the m-th third gating transistor is electrically connected to the second electrode of the m-th first gating transistor, and the second electrode of the m-th third gating transistor is electrically connected to the m-th first node;
a gate of the m-th fourth gating transistor is electrically connected to the m-th fourth control terminal, the first electrode of the m-th fourth gating transistor is electrically connected to the second electrode of the m-th second gating transistor, and the second electrode of the m-th fourth gating transistor is electrically connected to the m-th first node;
the m-th first gating transistor is a p-type transistor, the m-th second gating transistor is an n-type transistor, the m-th third gating transistor is a p-type transistor, and the m-th fourth gating transistor is an n-type transistor;
the m-th first control terminal is connected to an inverted signal of the (N−1)-th level driving signal, the m-th second control terminal is the (N−1)-th level driving signal output terminal, the m-th third control terminal is the N-th level driving signal output terminal, and the m-th fourth control terminal is connected to the inverted signal of the N-th level driving signal; or, the m-th first control terminal is connected to the inverted signal of the N-th level driving signal, the m-th second control terminal is the N-th level driving signal output terminal, the m-th third control terminal is the (N−1)-th level driving signal output terminal, and the m-th fourth control terminal is connected to the inverted signal of the (N−1)-th level driving signal;
wherein the second electrode of the m-th first pass transistor is electrically connected to the second electrode of the m-th second pass transistor.

5. (canceled)

6. The driving circuit according to claim 1, wherein the m-th gating circuit comprises an m-th first gating transistor;
the gate of the m-th first gating transistor is electrically connected to the m-th selection control terminal, the first electrode of the m-th first gating transistor is electrically connected to the m-th first node, and the second electrode of the m-th first gating transistor is electrically connected to the m-th selection input terminal.

7. The driving circuit according to claim 1, wherein the m-th gating control terminal comprises an m-th first gating control terminal and an m-th second gating control terminal; the m-th gating circuit comprises an m-th first gating transistor and an m-th second gating transistor;
a gate of the m-th first gating transistor is electrically connected to the m-th first control terminal, the first electrode of the m-th first gating transistor is electrically connected to the m-th first node, and the second electrode of the m-th first gating transistor is electrically connected to the first electrode of the m-th second gating transistor;
a gate of the m-th second gating transistor is electrically connected to the m-th second control terminal, and the second electrode of the m-th second gating transistor is electrically connected to the m-th selection input terminal;
the m-th first control terminal is the (N−1)-th level driving signal output terminal, the m-th second control terminal is the N-th level driving signal output terminal, the m-th first gating transistor is an n-type transistor, and the m-th second gating transistor is a p-type transistor; or,
the m-th first control terminal is the N-th level driving signal output terminal, the m-th second control terminal is the (N−1)-th level driving signal output terminal, the m-th first gating transistor is a p-type transistor, and the m-th second gating transistor is an n-type transistor; or,
the m-th first control terminal is connected to the inverted signal of the (N−1)-th level driving signal, the m-th second control terminal is the N-th level driving signal output terminal, and the m-th first gating transistor and the m-th second gating transistor are both p-type transistors; or,
the m-th first control terminal is an output terminal of the N-th level driving signal, and the m-th second control terminal is connected to the inverted signal of the (N−1)-th level driving signal; the m-th first gating transistor and the m-th second gating transistor are both p-type transistors; or,
the m-th first control terminal is the (N−1)-th level driving signal terminal, the m-th second control terminal is connected to the inverted signal of the N-th level driving signal, and the m-th first gating transistor and the m-th second gating transistor are both n-type transistors; or,
the m-th first control terminal is connected to the inverted signal of the N-th level driving signal, the m-th second control terminal is the (N−1)-th level driving signal terminal, and the m-th first gating transistor and the m-th second gating transistor are both n-type transistors.

8. The driving circuit according to claim 1, wherein the m-th control circuit further comprises an m-th first initialization circuit;
the m-th first initialization circuit is electrically connected to the initial control terminal, the first voltage terminal and the m-th first node respectively, and is configured to control the connection between the m-th first node and the first voltage terminal under the control of the initial control signal provided by the initial control terminal.

9. The driving circuit according to claim 1, wherein the m-th control circuit further comprises an m-th reset circuit;
the m-th reset circuit is electrically connected to the first voltage terminal, the (N−1)-th level driving signal output terminal, the (N−1)-th level driving signal output terminal and the m-th first node, respectively, and is configured to control a connection between the m-th first node and the first voltage terminal under the control of the (N−1)-th level driving signal and the (N−1)-th level driving signal provided by the (N−1)-th level driving signal output terminal.

10. The driving circuit according to claim 1, wherein the m-th control circuit further comprises an m-th first voltage maintaining circuit;
the first terminal of the m-th first voltage maintaining circuit is electrically connected to the m-th first node, the second end of the m-th first voltage maintaining circuit is electrically connected to the DC voltage end, and the m-th voltage maintaining circuit is configured to maintain the potential of the m-th first node.

11. The driving circuit according to claim 1, wherein the m-th control circuit further comprises an m-th second voltage maintaining circuit; the m-th first node is electrically connected to the second end of the m-th output control circuit through the m-th second voltage maintaining circuit;
the m-th second voltage maintaining circuit comprises an m-th first inverter, an m-th second inverter and an m-th maintaining control circuit;
the input end of the m-th first inverter is electrically connected to the m-th first node, the output end of the m-th first inverter is electrically connected to the m-th second node, the input end of the m-th second inverter is electrically connected to the m-th second node, and the output end of the m-th second inverter is electrically connected to the m-th third node and the second end of the m-th output control circuit;
the m-th first inverter is configured to invert the potential of the m-th first node, and output the inverted potential of the m-th first node through the output end of the m-th first inverter, and the m-th second inverter is configured to invert the potential of its input end, and output the inverted potential through the output end of the m-th second inverter;
the m-th maintaining control circuit is electrically connected to the m-th maintaining control terminal, the m-th third node and the m-th first node respectively, and is configured to control the connection or disconnection between the m-th third node and the m-th first node under the control of the m-th maintaining control signal provided by the m-th maintaining control terminal.

12. The driving circuit according to claim 2, wherein the m-th reset circuit comprises an m-th first transistor and an m-th second transistor;
the gate of the m-th first transistor is electrically connected to the (N−1)-th stage driving signal output terminal, the first electrode of the m-th first transistor is electrically connected to the first voltage terminal, and the second electrode of the m-th first transistor is electrically connected to the first electrode of the m-th second transistor;
a gate electrode of the m-th second transistor is electrically connected to the N-th stage driving signal output terminal, and a second electrode of the m-th second transistor is electrically connected to the m-th first node.

13. The driving circuit according to claim 11, wherein the m-th maintaining control terminal comprises an m-th first maintaining control terminal and an m-th second maintaining control terminal;
the m-th maintaining control circuit comprises an m-th third transistor and an m-th fourth transistor;
the gate of the m-th third transistor is electrically connected to the m-th first maintaining control terminal, the first electrode of the m-th third transistor is electrically connected to the m-th first node, and the second electrode of the m-th third transistor is electrically connected to the m-th third node;
the gate of the m-th fourth transistor is electrically connected to the m-th second maintaining control terminal, the first electrode of the m-th fourth transistor is electrically connected to the m-th third node, and the second electrode of the m-th fourth transistor is electrically connected to the m-th first node;
the m-th third transistor is a p-type transistor, and the m-th fourth transistor is an n-type transistor;
the m-th first maintaining control terminal is the (N−1)-th level driving signal terminal, and the m-th second maintaining control terminal is the control clock signal terminal; or,
the m-th first maintaining control terminal is an inverted clock signal terminal, and the m-th second maintaining control terminal is a control clock signal terminal;
or;
the m-th first inverter comprises an m-th fifth transistor and an m-th sixth transistor, and the m-th second inverter comprises an m-th seventh transistor and an m-th eighth transistor;
the gate of the m-th fifth transistor is electrically connected to the m-th first node, the first electrode of the m-th fifth transistor is electrically connected to the first voltage terminal, and the second electrode of the m-th fifth transistor is electrically connected to the m-th second node;
the gate of the m-th sixth transistor is electrically connected to the m-th first node, the first electrode of the m-th sixth transistor is electrically connected to the m-th second node, and the second electrode of the m-th sixth transistor is electrically connected to the second voltage terminal;
the m-th fifth transistor is a p-type transistor, and the m-th sixth transistor is an n-type transistor;
a gate of the m-th seventh transistor is electrically connected to the m-th second node, a first electrode of the m-th seventh transistor is electrically connected to the first voltage terminal, and a second electrode of the m-th seventh transistor is electrically connected to the m-th third node;
the gate of the m-th eighth transistor is electrically connected to the m-th second node, the first electrode of the m-th eighth transistor is electrically connected to the m-th third node, and the second electrode of the m-th eighth transistor is electrically connected to the second voltage terminal;
the m-th seventh transistor is a p-type transistor, and the m-th eighth transistor is an n-type transistor.

14. (canceled)

15. The driving circuit according to claim 8, wherein the m-th first initialization circuit comprises an m-th ninth transistor;
the gate of the m-th ninth transistor is electrically connected to the initial control terminal, the first electrode of the m-th ninth transistor is electrically connected to the first voltage terminal, and the second electrode of the m-th ninth transistor is electrically connected to the m-th first node.

16. The driving circuit according to claim 10, wherein the m-th first voltage maintaining circuit comprises an m-th capacitor;
the first terminal of the m-th capacitor is electrically connected to the m-th first node, and the second end of the m-th capacitor is electrically connected to a DC voltage terminal.

17. The driving circuit according to claim 1, wherein the m-th output control circuit comprises an m-th tenth transistor, an m-th eleventh transistor, an m-th twelfth transistor and an m-th thirteenth transistor;
the gate of the m-th tenth transistor is electrically connected to the m-th first node, the first electrode of the m-th tenth transistor is electrically connected to the first voltage terminal, and the second electrode of the m-th tenth transistor is electrically connected to the m-th second node;
the gate of the m-th eleventh transistor is electrically connected to the N-th stage driving signal output terminal, the first electrode of the m-th eleventh transistor is electrically connected to the first voltage terminal, and the second electrode of the m-th eleventh transistor is electrically connected to the m-th second node;
a gate of the m-th twelfth transistor is electrically connected to the m-th first node, a first electrode of the m-th twelfth transistor is electrically connected to the m-th second node, and a second electrode of the m-th twelfth transistor is electrically connected to a first electrode of the m-th thirteenth transistor;
the gate of the m-th thirteenth transistor is electrically connected to the N-level driving signal output terminal, and the second electrode of the m-th thirteenth transistor is electrically connected to the second voltage terminal;
the m-th tenth transistor and the m-th eleventh transistor are p-type transistors, and the m-th twelfth transistor and the m-th thirteenth transistor are n-type transistors.

18. The driving circuit according to claim 1, wherein the m-th output circuit comprises an m-th fourteenth transistor and an m-th fifteenth transistor;
the gate of the m-th fourteenth transistor is electrically connected to the m-th second node, the first electrode of the m-th fourteenth transistor is electrically connected to the first voltage terminal, and the second electrode of the m-th fourteenth transistor is electrically connected to the m-th output driving terminal;
the gate of the m-th fifteenth transistor is electrically connected to the m-th second node, the first electrode of the m-th fifteenth transistor is electrically connected to the m-th output driving terminal, and the second electrode of the m-th fifteenth transistor is electrically connected to the second voltage terminal.

19. The driving circuit according to claim 2, wherein the driving signal generating circuit comprises a first driving control circuit, a second driving control circuit, a second inverting circuit and a second initializing circuit;
the first driving control circuit is electrically connected to the control clock signal terminal, the inverted clock signal terminal, the (N−1)-th level driving signal output terminal and the fourth node respectively, and is configured to shift and invert the (N−1)-th driving signal provided by the (N−1)-th level driving signal output terminal under the control of the control clock signal provided by the control clock signal terminal and the inverted clock signal provided by the inverted clock signal terminal, and obtain and output the inverted signal through the fourth node;
the second driving control circuit is electrically connected to the control clock signal terminal, the inverted clock signal terminal, the N-th level driving signal output terminal and the fourth node respectively, and is configured to invert the N-th level driving signal provided by the N-th level driving signal output terminal under the control of the control clock signal and the inverted clock signal, and obtain and output the inverted signal through the fourth node;
the second inverting circuit is electrically connected to the fourth node and the N-th level driving signal output terminal respectively, and is configured to invert the potential of the fourth node and output the inverted signal through the N-th level driving signal output terminal;
the second initialization circuit is electrically connected to the initial control terminal, the first voltage terminal and the N-th level driving signal output terminal respectively, and is configured to control the connection between the N-th level driving signal output terminal and the first voltage terminal under the control of the initial control signal provided by the initial control terminal;
wherein the first driving control circuit comprises a sixteenth transistor, a seventeenth transistor, an eighteenth transistor, and a nineteenth transistor;
a gate of the sixteenth transistor is electrically connected to the inverted clock signal terminal, the first electrode of the sixteenth transistor is electrically connected to the first voltage terminal, and the second electrode of the sixteenth transistor is electrically connected to the first electrode of the seventeenth transistor;
a gate of the seventeenth transistor is electrically connected to the (N−1)-th stage driving signal output terminal, and the second electrode of the seventeenth transistor is electrically connected to the fourth node;
a gate of the eighteenth transistor is electrically connected to the (N−1)-th stage driving signal output terminal, the first electrode of the eighteenth transistor is electrically connected to the fourth node, and the second electrode of the eighteenth transistor is electrically connected to the first electrode of the nineteenth transistor;
a gate of the nineteenth transistor is electrically connected to the control clock signal terminal, and the second electrode of the nineteenth transistor is electrically connected to the third voltage terminal;
the sixteenth transistor and the seventeenth transistor are p-type transistors, and the eighteenth transistor and the nineteenth transistor are n-type transistors;
or
the second driving control circuit comprises a twentieth transistor, a twenty-first transistor, a twenty-second transistor, and a twenty-third transistor;
the gate of the twentieth transistor is electrically connected to the N-th stage driving signal output terminal, the first electrode of the twentieth transistor is electrically connected to the first voltage terminal, and the second electrode of the twentieth transistor is electrically connected to the first electrode of the 21st transistor;
a gate of the twenty-first transistor is electrically connected to the control clock signal terminal, and a second electrode of the twenty-first transistor is electrically connected to the fourth node;
a gate of the 22nd transistor is electrically connected to the inverted clock signal terminal, a first electrode of the 22nd transistor is electrically connected to the fourth node, and a second electrode of the 22nd transistor is electrically connected to a first electrode of the 23rd transistor;
a gate of the twenty-third transistor is electrically connected to the N-th stage driving signal output terminal, and a second electrode of the twenty-third transistor is electrically connected to the third voltage terminal;
the twentieth transistor and the 21st transistor are p-type transistors, and the 22nd transistor and the 23rd transistor are n-type transistors;
or
the second inverting circuit comprises a twenty-fourth transistor and a twenty-fifth transistor; the second initialization circuit comprises a twenty-sixth transistor;
a gate of the twenty-fourth transistor is electrically connected to the fourth node, the first electrode of the twenty-fourth transistor is electrically connected to the first voltage terminal, and the second electrode of the twenty-fourth transistor is electrically connected to the first electrode of the 25th transistor and the N-th stage driving signal output terminal;
a gate of the twenty-fifth transistor is electrically connected to the fourth node, and a second electrode of the twenty-fifth transistor is electrically connected to the third voltage terminal;
the twenty-fourth transistor is a p-type transistor, and the 25th transistor is an n-type transistor;
a gate of the twenty-sixth transistor is electrically connected to the initial control terminal, a first electrode of the twenty-sixth transistor is electrically connected to the first voltage terminal, and a second electrode of the twenty-sixth transistor is electrically connected to the N-th stage driving signal output terminal.

20-22. (canceled)

23. The driving circuit according to claim 2, wherein
the first inverter circuit comprises a twenty-seventh transistor and a twenty-eighth transistor;
the gate of the twenty-seventh transistor is electrically connected to the control clock signal terminal, the first electrode of the twenty-seventh transistor is electrically connected to the first voltage terminal, and the second electrode of the twenty-seventh transistor is electrically connected to the first electrode of the twenty-eighth transistor and the inverted clock signal terminal;
a gate of the twenty-eighth transistor is electrically connected to the control clock signal terminal, and a second electrode of the twenty-eighth transistor is electrically connected to the third voltage terminal.

24. A driving method, applied to the driving circuit according to claim 1, and comprising:
the driving signal generating circuit performs a shift operation on the (N−1)-th level driving signal under the control of the control clock signal, obtains and outputs the N-th level driving signal through the N-th level driving signal output terminal;
the m-th gating circuit controls, under the control of the m-th gating control signal, to write the m-th gating input signal into the m-th first node;
the m-th output control circuit performs a NAND operation on the N-th stage driving signal and the potential of the second end of the m-th output control circuit to obtain an m-th first output signal;
the m-th output circuit is configured to invert the m-th first output signal, and obtain an m-th output driving signal through the m-th output driving terminal;
M is a positive integer; m is a positive integer less than or equal to M, and N is a positive integer.

25. A display device comprising the driving circuit according to claim 1.
